(19) United States
(12) Patent Application Publication
(10) Pub. No.: US 2024/0391842 A1
(43) Pub. Date: Nov. 28, 2024

(54) ULTRASONIC REACTION FOR HIGH-YIELD PRODUCTION OF HUMIC ACIDS FROM COAL-LIGNITE, OXIDIZED COALS, AND RESIDUAL FEEDSTOCKS

(71) Applicants: Nashaat N. NASSAR, Calgary (CA); Abdallah D. MANASRAH, Calgary (CA); Redhwan AL-AKBARI, Calgary (CA)

(72) Inventors: Nashaat N. NASSAR, Calgary (CA); Abdallah D. MANASRAH, Calgary (CA); Redhwan AL-AKBARI, Calgary (CA)

(21) Appl. No.: 18/681,796

(22) PCT Filed: Aug. 3, 2022
(86) PCT No.: PCT/CA2022/051179

§ 371 Date: Feb. 6, 2024

Related U.S. Application Data
(60) Provisional application No. 63/230,353, filed on Aug. 6, 2021.

(51) Int. Cl. C05F 11/06; B01D 11/02; C07G 99/00

(52) U.S. Cl. CPC C05F 11/06; B01D 11/0265; B01D 11/028; B01D 11/0288; C07G 99/00

(57) ABSTRACT

Processes are disclosed for the ultrasonic functionalization and extraction of humic acids from carbonaceous feedstocks, in the presence of an oxidant in an alkaline extraction media. Humate fertilizers are provided by these processes, comprising potassium and nitrogen modified humic acids.

### FIELD

Innovations are disclosed in the field of aqueous systems for extraction of organic compounds from carboniferous solids.

### BACKGROUND

Coal is the most abundant type of fossil fuel, accounting for 64% of globally recoverable resources in the world, compared to oil (19%) and natural gas (17%). Coal is traditionally used in the energy sector, generating about 40% of the world's electricity. The demand for coal is expected to increase by over 60% from 2006 to 2030, of which developing countries will account for over 90%. The challenge that has been raised nowadays for electricity generation is how to maximize productivity, reduce energy consumption, and drastically reduce carbon dioxide (CO₂) emissions [2]. Therefore, the world has started phasing-out traditional coal-power electricity by 2030 to curb GHG emissions [3]. Consequently, a new technology, beyond combustion, is needed to create higher value-added products and offer a more efficient and cleaner use of coal, including its use in the production of electricity, steel and its associated products, and energy-related chemicals [4]. This in turn will leave large amounts of coals, specifically low-rank coals (i.e., lignite and sub-bituminous) idle. It is, therefore, imperative to look for alternative, sustainable, and economical ways for utilizing these resources. While significant progress has been made, it is still worth seeking new environmentally friendly and efficient usages of coal beyond these well-known applications. Such usages are not set to immediately replace the existing applications of coal, but instead provide alternatives so that whenever the opportunity arises, new market sectors can be generated and expanded as quickly and efficiently as possible [5]. Therefore, converting resources of coal and other feedstocks into value-add products, like humic acids, will add advantages for the coal application beyond combustion, especially when the produced products have many industrial applications like agriculture, pharmaceutical, and concrete. According to a new research report by Global Market Insights, the global market for humic acids is expanding to over USD 640 million in 2020 and will witness a compound annual growth rate of 12% [15]. The largest market application of humic acids includes agriculture, horticulture, dietary supplements, concrete, and ecological bioremediation.

Extracting humic acids from several sources including lignin, leonardite, compost, peat, Canadian humalite, manure and lignite have been reported [6,7]. These sources differ in availably, cost and the amount of generated humic acids [8]. Humic acid extraction using basic and acidic solutions is the most common method used today due to its simplicity [9-11]. Comprehensive studies were assembled and proposed, in which alkaline and acidic solutions were utilized to extract humic acids from soil [12]. Frost et al. [13] reported their findings on extraction steps of humic acids from coal and leonardite using several alkalis extraction where the yielded humic acids contain less ash. In 1981, the International Humic Substance Society (IHSS) published the standardized procedure for humic acid extractions [14]. This publication contained guidelines on testing soils and coal for humic acids (i.e. HA) with a procedure very similar to that developed by Frost et al [12]. This method is still used today as the main method for the extraction and quantification of humic for testing soils and producing humic acids commercially. While aqueous extraction of humic acid using bases and acids is a well-established method, it has some disadvantages. Such disadvantages include the use of strong acids and bases as well as the requirement for fresh acids and bases for each extraction step. Furthermore, aqueous extraction requires materials that can handle both high and low pH conditions, this can increase the cost of materials at a large scale. These challenges and others have pushed researchers to find a suitable organic solvent for the effective extraction of humic acid. Thiessen and Engelder [15] suggested the use of hot acetone as an organic solvent to extract HA from dried decayed wood. Polansky and Kinney [16] tested over 250 different solvents to extract HA and the ratio of 50-90% acetone and water was recommended. Frost et al. [13]also tested acetone to water at 3:1 ratio and found that HA can be soluble at that ratio. Other researchers tested multiple solvents including EDA, pyridine, sulpholane, DMF, and EDTA, but none performed as well as the NaOH in the IHSS extraction method [17]. While several researchers showed that organic solvents can possibly be used to replace basic/acidic extractions for obtaining HA, organic solvent still suffer from lower yield, high cost, and complex extraction procedure. Other reported processes include ion exchange and thermal oxidation [18,19]. Such methods, however, have major limitations include the low reaction kinetics, multiple step operations, high operating temperatures and low yield.

### SUMMARY

Processes are disclosed for using ultrasonic energy to enhance the yield and quality of humic acids obtained by chemical and physical conversion of carbonaceous feedstocks into humic substances. Ultrasonic processing is believed to provide cavitation, in which ultrasound generates microbubbles that grow and eventually collapse causing high localize pressure and temperature. Chemical and physical effects during ultrasonic processing lead to higher rates of desirable reactions. The effects of a number of parameters have been exemplified, including amplitude, reaction time, initial feedstocks concentration, type and amount of alkaline solution, and the concentration of H₂O₂. The international standard ISO19822 method was employed for product characterization. Product characterization also include the use of FTIR, TOC, CHN analysis and TGA. The characterization confirmed the conversion of lignite, oxidized coals, petcoke, biochar and asphaltene to organic acids, allowed for the quantification of humic acids and provided insights on the chemical and physical characteristics of the products. A lump kinetics model was built to establish the kinetics triplets, (i.e., reaction order, activation energy and pre-exponential factor). This approach is shown to produce high yield and conversion with selectivity for humic acids in conjunction with negligible direct CO₂ emissions.

Processes are accordingly disclosed for the ultrasonic functionalization and extraction of humic acids from carbonaceous feedstocks, in the presence of an oxidant in an alkaline extraction media. Humate fertilizers are thereby provided by these processes, comprising potassium and nitrogen modified humic acids.

In select implementations, processes are accordingly provided for producing humic acids from a solid carbonaceous feedstock comprising a humic substance content and a carbon content. Processes may include, but are not limited to, the following steps:
1) mixing a comminuted carbonaceous solids fraction derived from the solid carbonaceous feedstock with an alkaline solution to produce a pre-solubilized slurry, wherein the slurry is characterized by a weight ratio of comminuted carbonaceous solids to water of from 1:20 to 1:7;
2) treating the pre-solubilized slurry under extraction conditions in a basic aqueous extraction medium for an effective extraction residence time period of less than 5, 4, 3, 2 or 1 hour to extract humic acids from the comminuted carbonaceous solids, wherein the extraction conditions comprise:
   i) ultrasonic sonication at 10-30 kHz, e.g. 20 kHz;
   ii) H₂O₂ at an H₂O₂ concentration of between 1% and 5%;
   iii) an extraction temperature of from 25° C. to 60° C., or 10° C. to 80° C. or at an ambient temperature;
   iv) KOH and NH₄OH, wherein the NH₄OH is present at an N:K molar ratio to the KOH, and wherein the N:K molar ratio is from 0.5:1 to 1:0.5, and wherein the NH₄OH and KOH are present in a combined concentration that maintains alkaline conditions of pH 8 to 12 in the presence of the H₂O₂;
   wherein the extraction conditions are effective during the extraction residence time period:
   i) to solubilize at least 80%, 85%, 90% or 95% of the carbon content of the carbonaceous feedstock, and
   ii) to covalently incorporate nitrogen and potassium into a humic acids product; and,
3) separating a humic acid solution product stream from residual solids and recovering the humic acid solution product stream, wherein the humic acid solution product stream comprises the humic acids product and a fulvic acids product, wherein the conversion of the humic substance content of the carbonaceous feedstock into the humic acids product of the humic acid solution product stream provides an ash-free humic acid yield of at least 60%, 65%, 70%, 75% or 80%; and wherein the proportion of the humic substance content of the carbonaceous feedstock converted to CO₂ under the extraction conditions during the extraction time period is less than 2%, 1% or 0.5%.

The carbonaceous feedstock may for example include one or more of: a coal, such as a lignite, a biochar, a petroleum coke or an asphaltene. The comminuted carbonaceous solids fraction may be derived from the solid carbonaceous feedstock by being comminuted to a size of 50-950 μm, optionally 50-750 μm. Conversion of the humic substance content of the carbonaceous feedstock into the humic acids product of the humic acid solution product stream provides an ash-free humic acid yield of at least at least 60%, 65%, 70% or 75%. The effective extraction residence time period may for example be less than about 5, 4, 3, 2, 1 or 0.5 hour. Processes may be continuous or batch processes. The resulting humic acid solution product stream may be acidified to precipitate the humic acids product, separating that product from a fulvic fraction product.

### BRIEF DESCRIPTION OF THE DRAWINGS

FIG. 1 Simplified experimental drawings (not to scale)

FIG. 2 A simplified experimental flow diagram showing the major step used in the experimental work of humic acid extraction.

FIG. 3 Process flow diagram for the continuous mode of the ultrasonic process.

FIG. 4 The ISO 19882 procedure to determine the amount of humic acids extracted from a certain sample

FIG. 5 Conversion of lignite (X) against time in minutes with operational conditions of 1:1 KOH to lignite, 40% ultrasonic amplitude, and 3% H₂O₂.

FIG. 6 The yield of humic acids at operational conditions of 1:1 KOH to lignite, 40% amplitude, and 3% H₂O₂.

FIG. 7 Effect of ultrasonic amplitude on the amount of solubilized carbon in the liquid portion after the reaction compared to original carbon found in lignite, operational conditions are: 3% H₂O₂, 1:1 KOH to lignite and 05:01 seconds pulses. C: amount of organic carbon dissolved, Co: amount of original carbon in lignite.

FIG. 8 Effect of H₂O₂ concentration on the solubilization of carbon in the solution. Conditions are: 1:1 KOH to lignite, 40% amplitude. C: amount of organic carbon dissolved, Co: amount of carbon in the original lignite

FIG. 9 Proposed mechanism of the ·OH radical attack on the lignite molecule (molecular model [58]) causing the formation of carboxylic and —OH function groups.

FIG. 10 Effect of the KOH to lignite ratio on the solubilization of carbon in the solution. Conditions are: 20 min time, 40% amplitude, 3% H₂O₂. C: amount of organic carbon dissolved, Co: amount of carbon in the original lignite.

FIG. 11 Effect of using NH4OH on the amount of carbon solubilized and amount of nitrogen incorporated in the final products. Conditions are: Amplitude: 40%, time: 20 min, 3% H₂O₂. C: amount of organic carbon dissolved, Co: amount of carbon in the original lignite.

FIG. 12 The effect of the amount of lignite in 20 mL water on the solubilization of carbon. Conditions are: 40% amplitude, 20 min, 1:1 KOH to lignite ratio, 3% H₂O₂. C: amount of organic carbon dissolved, Co: amount of carbon in the original lignite.

FIG. 13 Total carbon reported after the reaction of petcoke, asphaltene and biochar with H₂O₂ under alkaline solution for 1 hour reaction time, 5% H₂O₂ and 80% ultrasonic amplitude

FIG. 14 FTIR spectra of raw and untreated lignite, humic acids and residue obtained from ultrasonic conversion under the following conditions: 40% amplitude, 20 min reaction time, 1:1 KOH ration and 3% H₂O₂.

FIG. 15 Two spectra of humic acids. Humic acids K is the one where KOH is used for extraction under ultrasonic amplitude of 40%, 20 min reaction time, 1:1 KOH to lignite ratio, 3% H₂O₂ and Humic acid N is where NH₄OH is used for extraction under ultrasonic amplitude of 40%, 20 min reaction time and 3% H₂O₂.

FIG. 16 Thermogravimetric analysis of a humic acids sample obtained at 3% H₂O₂, reaction time of 20 min, amplitude of 40% and 1:1 KOH to lignite ratio. Heating rate from 10° C./min to 50° C./min and flow rate of 100 mL/min. HV: high volatiles, MV: medium volatiles, FC: fixed carbon, A: ash.

FIG. 17 Thermogravimetric analysis of the residue obtained at 3% H2O2, reaction time of 20 min, amplitude of 40% and 1:1 KOH to lignite ratio. Heating rate from 10° C./min to 50° C./min and flow rate of 100 mL/min. HV: high volatiles, MV: medium volatiles, FC: fixed carbon, A: ash.

FIG. 18 Thermogravimetric analysis of original lignite. Heating rate from 10° C./min to 50° C./min and flow rate of 100 mL/min. HV: high volatiles, MV: medium volatiles, FC: fixed carbon, A: ash.

FIG. 19 Concentration profiles for A and B with the model fit at T=322 K

FIG. 20 Concentration profiles for A and B with the model fit at T=315 K

FIG. 21 Concentration profiles for A and B with the model fit at T=310 K

FIG. 22 Arrhenius plots for model developed plotting natural log of reaction constants against the reciprocal of temperature in kelvin

FIG. 23 Formation of humic acids at two flow rates obtained during the testing of the continuous mode

### DETAILED DESCRIPTION

As disclosed herein, ultrasonic processing has been utilized for the production of humic acids from coal-lignite, oxidized coals, and other residual feedstocks. Ultrasound in an aqueous medium provides two activation phenomena: physical and chemical. The physical includes acoustic cavitation and acoustic streaming [23, 24]. Acoustic cavitation refers to the creation and collapse of bubbles in the medium while acoustic streaming refers to the steady flow in a medium caused by the absorption of high amplitude acoustic oscillations. On the other hand, the chemical phenomenon (i.e., sonochemistry) includes the creation of free radicals and the temperature effect. Ultrasound energy produces highly reactive species such as ·OH radicals, H₂O₂, and ozone which are strong oxidizing agents with high oxidation potentials [23]. As disclosed herein, those produced species can contribute to increasing the yield of humic acids through increasing the availability of loading sites for K+ coming from KOH, which will allow humic acids species to be dissolved easily as humates in the solution. Ambedkar et al. [25] studied the ultrasonic mechanism for the fragmentation of coal (type of coal unspecified) in an aqueous medium at low-frequency ultrasound (25 kHz). They found that coal particle breakage occurs under ultrasound in two ways, namely pitting of the coal surface to produce fines and crack formations, which are further widened and deepened upon prolonged ultrasound exposure. The combination of these effects leads to the breakage of hydrocarbon-impurity bonds, removal of slime coatings from coal, driving of reagent into the core of the particles, improvement of mass transfer of the process, enhancement of surface area of coal particles and finally helps in improving the physical and physio-chemical effects. In that case, coal structure will be incorporated with oxygen functionality which may be taken place by the conversion of alcohol or aldehyde groups to carboxyl, breaking a carbon chain at some susceptible linkage such as the olefin type to form carboxylic, or the formation of phenolic structures. New acidic groups are formed in the conversion of coal to humic acids. These acid groups have been found to contain both carboxyl and phenolic groups [27]. These oxygen functional groups such as phenol, carboxyl, hydroxyl, enolic-OH, and ketone help to increase the cation exchange capacity of the soil [28]. Other functional groups such as amines (R—NH₂) and sulfur (S═O═S) modify the chemical properties of the soil, stimulate biologically plant growth, and cause the HA to be more biologically active [28].

In select aspects, processes are provided as summarized in Table 1.

TABLE 1

| Conditions | Process |
|---|---|
| Raw Materials | Coal, Biochar, petroleum coke, Asphaltene |
| Quality of products | Following the ISO19822 standard |
| Conversion | >90% |
| Yield of humic Acid | >70% |
| Temperature (° C.) | 25-60 |
| Oxidizing agent | H₂O₂ |
| Media | KOH, NH₄OH, and combinations thereof |
| Reaction Time | 5-45 mins |
| Raw material to water ratio | 1-20 to 1-7 |
| CO₂ Emission | Negligible |
| Conditions | 20 kHz, optionally 10-30 kHz |
| Process configuration | One ultrasonic step process, optionally |
| | without high-speed mixing |

Processes are accordingly provided having high yield conversion under alkaline conditions using a wide range of carbon-based materials. In effect, these processes combine three reactions in one process step: saponification, oxygenation, and ultrasonic treatment. Extraction conditions are exemplified that result in a high yield of humic acids and almost zero CO₂ emissions. Nitrogen and potassium are covalently incorporated into the humic acid product through saponification and partial oxidation by H₂O₂. The incorporated nitrogen and potassium provide plant nutrients as part of the humic acid structure, and also increase the solubility of the humic acid product in water. Ultrasonic sonication in the extraction conditions accordingly mediates two processes: a physical destruction of carbonaceous feedstock aggregates and particles; and, a chemical generation of OH radicals that facilitates cracking the carbonaceous feedstock to form humic acids (a term that includes humic acid analogs).

### Examples

### Materials

Coal-lignite, oxidized coal (sub-bituminous, humalite, Leonardite), Peat and different types of residual feedstocks have been used as described herein to convert the feedstock into humic acids using an ultrasonic process. Low-rank coal lignite was purchased from Ward's Science (Rochester, NY, United Stated of America). The samples are black with brownish strikes with sizes of specimens in the range of 2.54×2.54 cm to 2.54×5.08 cm. The source of this lignite is Bowman North Dakota USA. Sub-bituminous coal is obtained from Dodds coal mine in Alberta. Leonardite, which is by nature a sustainable and efficient raw material that is formed by weathering from deposits of lignite, was obtained from Leonardite Products, North Dakota, USA. Humalite is a naturally oxidized coal-like material similar to Leonardite but has a much higher humified organic matter content and significantly lower residuals is obtained from Black Earth Humic LP, Calgary, Alberta. Peat was purchased from a local supplier in Calgary, Alberta. Green petroleum coke (petcoke) sample was obtained from Marathon Petroleum Company (Garyville, USA). Biochar sample was purchased from Canadian AgriChar (British Columbia, Canada), and C₇-Asphaltene was extracted from Canadian Oil (Nexen-CNOOC Ltd). These samples were crushed to get size ranges from 53 to 710 μm using a grinder. To create alkaline media, potassium hydroxide (KOH) and ammonium hydroxide (NH₄OH) were purchased from Sigma-Aldrich (Ontario, Canada). KOH comes as pellets with purity of over 85%, while NH₄OH comes as a solution of 28.0-30.0 wt. % NH₃ basis. Hydrogen peroxide solution of 35 wt. % obtained from VWR (Ontario, Canada) was used as an oxidant. Hydrochloric acid (HCl) was also acquired from Sigma-Aldrich (Ontario, Canada) with 37 wt. % concentration. These chemicals were diluted to desired concentration using water. Further characterization of the lignite sample has been fully investigated and analyzed using carbon, hydrogen and nitrogen analyzer (CHN) and the results were 59.1 wt. % carbon, 4.16 wt. % hydrogen and 1.09 wt. % nitrogen and the rest assumed to be oxygen with traces of metals and sulphur. For C₇-Asphaltene, the elemental analysis shows 81.7 wt. % carbon, 7.8 wt. % hydrogen and 1.22 wt. % nitrogen [20]. Petcoke has 84.48 wt. % carbon, 3.81 wt. % hydrogen, and 1.55 wt. % nitrogen [21]. Biochar sample was also analyzed, and it has 77.75 wt. % carbon, 5.19 wt. % hydrogen, and 0.46 wt. % nitrogen.

### Ultrasonic Sonication

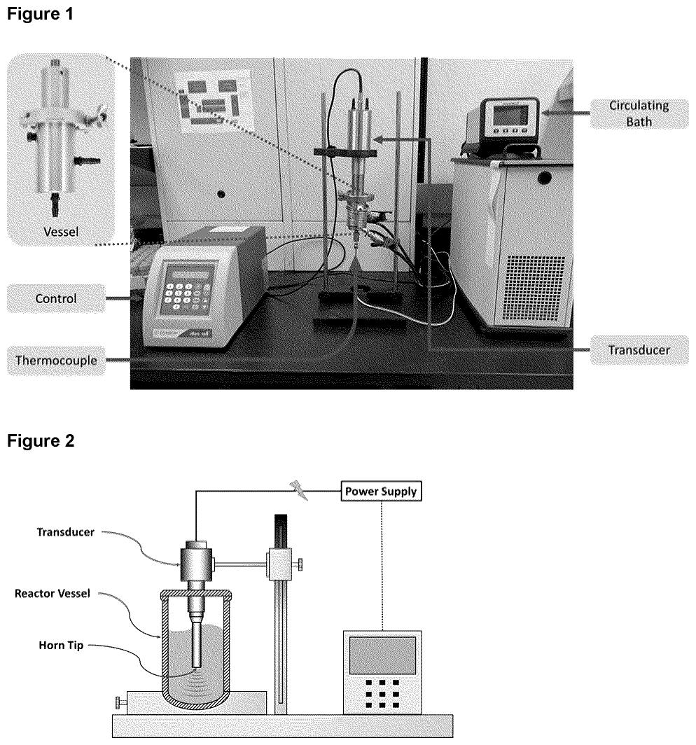

The ultrasonic reaction was carried out using the ultrasonic vessel which acts as a reactor unit for the batch mode. The setup consists of medium volume cell of 65 mL maximum volume and rated to a maximum pressure of 100 psi. The cell is fixed in place using a clamp connected to a support stand. The ultrasound waves are generated using a probe made of titanium alloy (Ti-6Al-4V). The probe tip diameter is 13 mm with 136 mm length. The probe is part of the converter. The converter also has a piezoelectric transducer. The transducer converts the electrical energy to vibrations. The converter is connected to a control panel. The control panel allows for the modification of time, amplitude and pulses. It also registers the amount of energy supplied to the reaction vessel through the reaction time. At the bottom of the vessel, a temperature probe is connected to monitor the temperature of the solution inside the vessel. The whole setup is enclosed in sound abating enclosure (not shown in the picture). A copper tube is wrapped around the vessel to circulate water from the water path, which allows for the cooling of the reaction vessel. FIG. 1 shows a simplified schematic for the experimental setup.

### Ultrasonic Continuous Processing

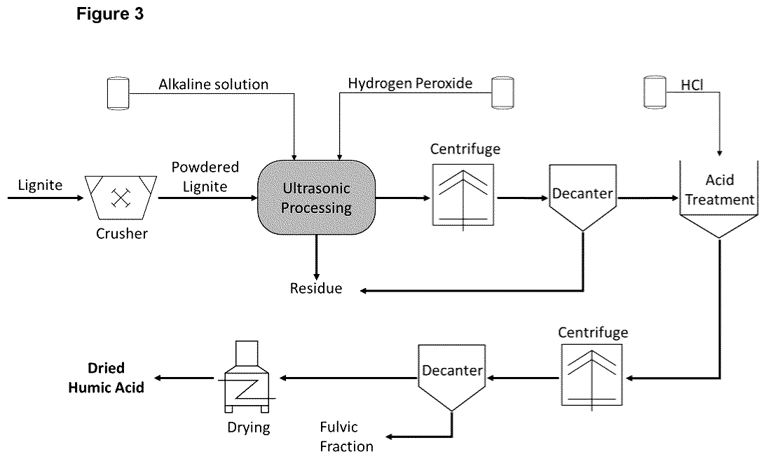

The ultrasonic reactor can also be operated in continuous mode. Feedstock, alkaline substance, water, and the oxidant are mixed in a pre-mixing tank prior to pumping. The mixture is pumped at various flow rates to achieve different residence times. A sample of the material is taken before and after the reactor through three-way valves. The amplitude, time, and pulses of the ultrasonic reactor are controlled from the control panel. Temperature measurements are taken every minute during the reaction. The reactor is operated at steady state, where the flow rate into the reactor is equal to the flow rate out of the reactor. FIG. 3 shows the major components involved in the continuous mode of the reactor setup and its assembly, including the reactor itself, along with mixing tank, pump, valves, and collection vessel.

Production of Humic Acids from Lignite, Oxidized Coals and Different Residual Feedstocks Using Ultrasonic Reaction

The reaction takes place by mixing different types of oxidized coals, lignite, Peat, biochar, asphaltenes, and petcoke, individually with alkaline solution containing hydrogen peroxide in the ultrasonic reactor.

FIG. 2 represents the process flow diagram of the steps taken during the ultrasonic processing of lignite to humic acids. Worth noting here that this procedure was applied for all the aforementioned residual feedstocks. First, raw lignite is crushed to obtain powdered lignite for easy operation and to improve the mass transfer. Powdered lignite is then mixed with alkaline solution and H₂O₂ is added to the mixture. The mixture of powdered lignite, alkaline solution and H₂O₂ is then ultrasonically processed based on desired amplitude and reaction time. Once the reaction is completed, the liquid portion and any residue left are collected. The residue is dried and weighed for characterization. The liquid portion is centrifuged to allow any suspended materials to settle. The settled materials are collected, dried and weighted. The supernatant is then mixed with HCl until the pH of the solution reached 1 and the humic acids start to precipitate. Supernatant with the precipitated humic acids is centrifuged to get any suspended humic acids to settle. After centrifuging, fulvic fraction (the remaining supernatant) is decanted from the precipitated humic acids. The humic acids are then dried and weighted. The details for the process of separating humic acids from fulvic fraction are laid out in the ISO 19822 procedure. All materials obtained were characterized using FTIR, TGA, TOC and CHN analyzer.

### Characterization Studies

### International Standardization ISO 19822 Method for Quantification of Humic Acids

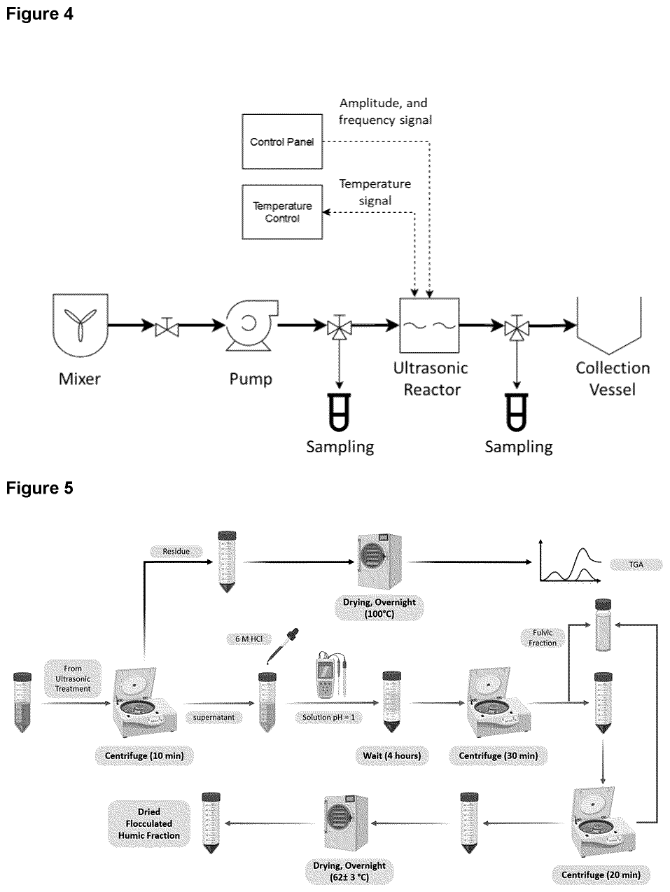

ISO 19822 is an internationally recognized method for determining the concentration of humic acids in materials. FIG. 4 simplified the ISO 19822 procedure for the determinations of humic acids contents in any sample. This quantification method is similar to the International Humic Substances Society (IHSS) method that was detailed by Stevenson [22,23]. ISO 19822 defines humic acids as an alkali extracted humic substance that is insoluble in strongly acidic solutions and precipitated at pH of 1. The liquid remaining after precipitation is referred to as fulvic fraction.

The hydrochloric acid solution is used as a reagent. Apparatuses include analytical balance with draft guard, drying oven, centrifuge, centrifuge tubes, and pH meter. The process starts with homogenizing the liquid sample by shaking it for 1 min and weighing 5 g test portion. While stirring, 6 M HCl was added to the test portion until pH reached 1±0.1. During this time, humic acids start to precipitate. The container was then covered with parafilm for 1 h. After 1 h, the pH of the test portion was checked again to determine if it still at 1. If not, it was adjusted using either 6 M HCl or 0.5 M NaOH. After the pH is stabilized, the test portion was left for 4 h undisturbed. After 4 h±5 min, the solution was centrifuged for 30 min at 3900×g (relative centrifugal force (RCF)). The supernatant was decanted (fulvic fraction). After decanting, the flocculated humic acid is centrifuged at 1500×g for 20 to 30 min for further separation from the liquid fulvic fraction. Then the flocculated humic acids are dried in a vacuum oven at 62±3° C. overnight up to 24 h. In this work, 24 h was ideal. Then, the dried flocculated humic acids are transferred to the TGA to determine the ash content. During these steps, the weight of containers is recorded before and after to use in the calculations.

### Total Organic Carbon (TOC)

Shimadzu Total Organic Carbon Analyzer (TOC-L CPH/CPN, Mandel, USA) was utilized to measure the total carbon (TC), total organic carbon (TOC), and inorganic carbon (IC) in the aqueous phase obtained after the reaction. TC is all carbon in sample containing both organic and inorganic. TIC refers to carbonate, bicarbonate and any dissolved carbon dioxide. TOC is typically organic carbon coming from decaying vegetation and metabolic activities. The TOC analyzer passes through three stages, acidification, oxidation and detection and quantification. Acidification allows the liberation of carbonates and bicarbonates to CO₂. Oxidation converts the remaining carbon in the sample to CO₂ using high-temperature catalytic oxidation. For this study, the amount of TOC was considered to determine the humic substances are organic materials. After the reaction taking place, the sample was centrifuged to get rid of any suspended particles. 1 mL of the sample was diluted with 12 mL of water in TOC analyzer vials. Three vials were prepared for each measurement to reduce human error and confirm reproducibility. TOC measurements were done for all samples. TOC measurements were reported in a ratio of TOC to original carbon in the feedstock (C/Cₒ).

### Fourier-Transform Infrared Spectroscopy (FT-IR)

FT-IR is used to identify chemical substances and functional groups based on the fact that each molecule or functional group has a certain adsorption frequency. FT-IR is a very useful tool for the identification of humic acids in a sample through the determination of functional groups such as —COOH and —OH. In this study, IRAffinity-1S from Shimadzu Corporation (Model No. 3116465 Mandel, USA) was used to carry out the analysis. All tested samples were dried at 62° C. in vacuum oven for 24 h. Initially, KBr was used as a background and then very small amounts of humic acids, residual carbon after reaction and lignite were mixed individually with KBr and analyzed. The sample was crushed to a smooth powder and added to the sample compartment. The resolution was 2 cm⁻¹ and spectra were from 400 to 4000 cm⁻¹.

### Thermogravimetric Analysis (TGA)

The TGA/DSC analyzer (SDT Q600 TA Instruments, Inc., New Castle, DE) was used to test the samples of produced humic acids, residual materials and original sample (lignite and residual feedstocks). The results are used to measure the ash content that presents in humic acids and the contents of carbon in the remaining residual after the reaction. The moisture content (high volatile matter), volatile matter (medium volatile matter) and fixed carbon were reported for the measurement as well. After the solid sample of humic acid was extracted and isolated from the liquid solution as explained previously, it was placed in an open crucible made of alumina then the crucible is transferred to the sample holder in the TGA compartment. According to ASTM E1131 [24], the sample was firstly pyrolyzed under N₂ to measure moisture and volatiles. Then the gas is switched to air for combustion to measure fixed carbon and ash. The temperature was raised to 110° C. and kept constant for 5 min, then raised again to 950° C. and kept constant for 15 min. N₂ is switched to air and combustion continuous until constant weight is achieved.

### Elemental Analysis (CHN Analyzer)

The PerkinElmer 2400 Series II (Waltham, Massachusetts, USA) was used to determine the concentration of carbon, hydrogen and nitrogen in humic acids, residuals and lignite. The principle behind the device is the flash combustion of the materials using the classical Pregl-Dumas method. The gases resulting from the combustion are measured and analyzed by thermal conductivity detector. The samples were dried and homogenized before utilization. The results offer a more concise measurement of carbon content in the samples. The carbon content was later used in modeling calculations. Nitrogen content is important as well to know how much nitrogen is in the product after using NH₄OH as an alkali in the extraction.

### Exemplified Results

This section presents the results obtained from ultrasonic process of lignite and provides explanations of the trends and reaction mechanism under different reaction conditions during the ultrasonic processing. Other oxidized coals and residual feedstocks, such as biochar, asphaltenes, and petcoke were processed at the optimized conditions to evaluate the ability of using this process for a wide variety of feedstocks.

### Reaction Conversion and Yield of Humic Acids

The conversion of lignite to products (humic substances) was calculated after measuring the amount of lignite reacted compared to the virgin amount used at the beginning of the experiment according to the following equation:

$$\% Conversion ( X ) = \frac{Amount of reacted lignite}{Amount of original lignite} \times 100 \qquad ( 1 )$$

The amount of reacted lignite was calculated as the difference between the initial amount and residual amount. FIG. 5 shows the conversion of lignite to products (HA) over the reaction time at 3% H₂O₂, 40% ultrasonic amplitude and 1:1 KOH to lignite ratio. As shown, the reaction time plays an important role in forming HA since the conversion is increased with the reaction time. The maximum conversion of 92% was achieved at a reaction time of 30 min. It is worth noting that the increase of conversion with time is attributed to the increase in the amount of energy supplied to the solution. This energy causes more physical and chemical effects. Physically in terms of more mixing happening because of the microjets caused by the ultrasonic waves. Chemically in terms of more ·OH radicals liberated causing more oxygenation of lignite which creates more —COOH and —OH groups. The role of ·OH radical in oxygenating organic molecules has been reported by Stavarache et al. [25] where the conversion of chlorobenzene to phenols and chlorophenol through radical formation during ultrasonic processing was studied. These functional groups are ideal landing sites for K⁺ which increases the solubilization of humic acids and breakage in hydrophobic and hydrogen bonding [26-29]. Overtime, more lignite particles are exposed to the ·OH radicals formed, and KOH is getting attached to the functional groups in the molecules causing more solubilization in the liquid phase and less residue left over after the reaction [30-35]. Details of the reaction mechanism will be explained in the next section.

The yield of forming humic acids was calculated based on the amount of ash-free humic acids formed during the reaction compared to the amount of original lignite according to the following equation:

$$\% Yield ( Y ) = \frac{Amount of Humic Acid}{Amount of original lignite} \times 100 \qquad ( 2 )$$

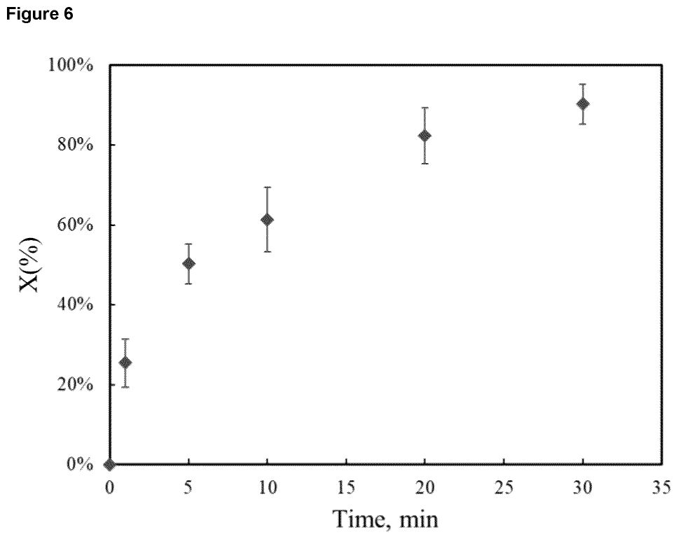

FIG. 6 shows the yield percentage of humic acids obtained from lignite at various times at 3% H₂O₂, 40% ultrasonic amplitude, and 1:1 KOH to lignite ratio. As shown, similar to the conversion trend, the yield of HA is increased with the reaction time and the highest yield was obtained after 30 min is 72%. Fong et al. reported a maximum yield of 67% at higher temperature than this study (70° C.) and higher reaction time (2 hours) [36]. Zhang et al. achieved a maximum yield of 48% of humic acids from lignite at 2 hours reactions times[37]. Syahren et al. reported a yield slightly more than 60% at 90° C. [38] By comparing the conversion, FIG. 5, with the yield of HA, we can see that there are other forms of produced materials from lignite that can be generated other than humic acids. Such produced materials are typically fulvic acids analogs, a smaller molecule than humic acids with lighter color, which is considered part of humic substances. These materials were separated during the quantification experiments. As time increases, the intensification of the process increases causing more humic acids to break into smaller acids. These observations have been reported in the literature, for example, Doskocil et al. [39] found that humic acids can be converted into smaller acids such as malonic acid and succinic acid. Gong et al. [40] reported the production of fulvic acids from low-rank coals using H₂O₂. Fulvic acids are commercially viable products used in agriculture and medicine as well.

### Effect of Operational Parameters on the Production of HA

In this section, the effects of several operational parameters are discussed namely: KOH to lignite ratio, water to lignite ratio, amplitude percentage, the concentration of H₂O₂ and the type of alkaline media.

### Effect of Ultrasonic Amplitude

The ultrasonic probe or horn transmits ultrasonic vibrations to the liquid that is being sonicated and thus creating cavitation. The amplitude is defined as the distance between the position of the probe fully extended and fully contracted and is measured in micrometres. For each setup, there is a maximum distance, and the amplitude is typically reported in percentage of that maximum. Once the amplitude is set, it stays the same for the entire duration of the reaction even if other parameters and conditions were varied. Higher amplitudes correspond to higher ultrasonic intensity and vice versa.

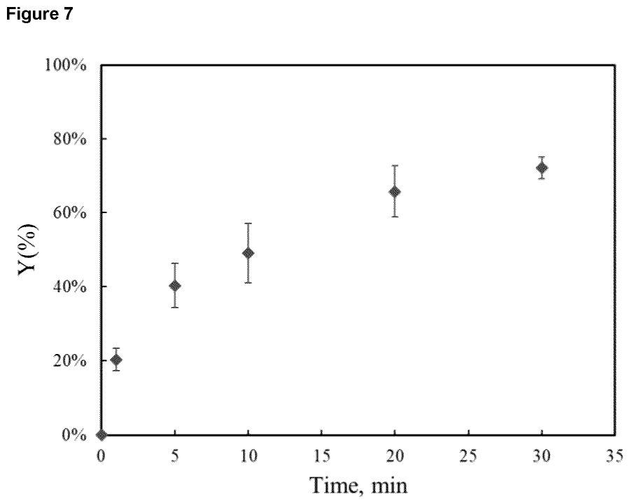

In this study, three different amplitudes ranging from 20% to 40% were considered here to investigate its effects on the solubilization of organic materials from lignite and the production HA. It should be noted that higher amplitudes (>40%) are to be avoided in this process as high emissions of CO₂ can happen due to high temperatures at these amplitudes. FIG. 7 shows the effect of amplitude on the ratio of C/Co at 3% H₂O₂, 1:1 KOH to lignite ratio where C is the amount of organic carbon solubilized during the reaction at any time and Co is the amount of carbon in virgin lignite, before reaction. As shown, the amount of carbon solubilized is increased with the increase of amplitude. With the increase of amplitude more energy is being transformed to the solution resulting in higher temperature and more mixing thus increasing the contact between molecules and increasing the radical formation resulting in more solubilized materials. At higher amplitudes, lignite particles can be fragmented into smaller ones increasing the surface area and mass transfer. Oroian et al. [41] reported the effect of amplitude on the extraction of the bioactive compounds from propolis and observed an increase in extraction rates with higher amplitude. Others have reported higher extraction yield of phenolic compounds from waste [42]. Furthermore, the effect of ultrasonic amplitude has been studied on various aspects such as morphology of nanocrystals, particle size of coal and reagent consumption in froth flotation with favourable results [43-45].

It is worth noting that the effect of reaction time is very crucial as more time passes, the amount of energy supplied to the reaction is higher consequently leads to higher ultrasonic power. Power is the measure of energy per unit time and is typically reported in terms of watts (W) or kilowatts (kW). The ultrasonic control panel displays the energy supplied to the reaction. In this study, various time durations have been tried in the range from 1-45 min. At each time, the reaction conversion was measured to observe the trend of humic acid formation. For each time interval (1, 5, 10, 20, 30, and 45 min) various amplitudes and concertation of chemicals were tested.

Effect of H₂O₂ Concentration

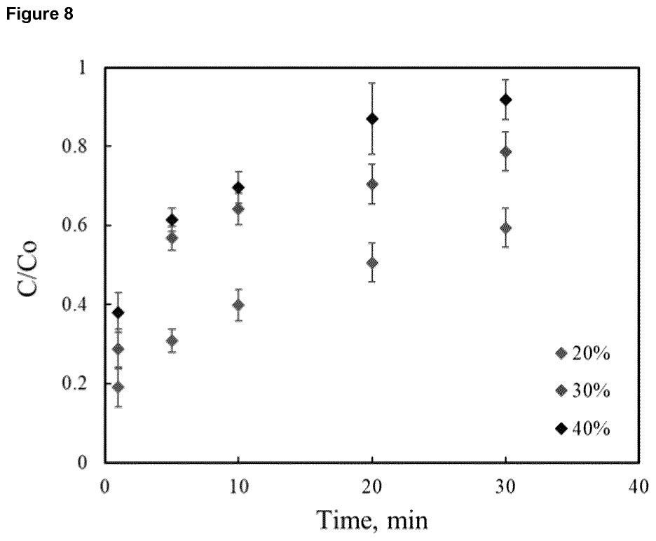

The use of an oxidant is important to increase the amount of humic acids retrieved from lignite. The oxidant role is to provide radicals and oxygenate the functional groups in lignite. Several oxidants have been tested in the literature and H₂O₂ was chosen in this study because it is the ultimate environmental oxidant and its by-products are not harmful [46]. Other oxidants such as HNO₃ and KMnO₄ can result in harmful gas being released and can cause corrosion to the reactor vessel. H₂O₂ was considered here as an oxidizing agent to generate ·OH radicals that can attack the lignite molecule thus increasing the content of oxygenated functionalities such as carboxylic and phenolic functional groups. Under ultrasonic processing, H₂O₂ disassociates to radicals that attack certain landing spots on the lignite molecules. Increasing the concentration of H₂O₂ can result in better solubilization and more humic acids as more ·OH radicals are available for the reaction. However, lower amounts are better for economical purposes since part of the cost of humic acids will be attributed to the chemical utilized in the production. Several concentrations of H₂O₂ have been tested ranging from 1% to 5%. At each concentration, the conversion was calculated, and other parameters were changed such as amplitude to see the impact of that on the conversion. FIG. 8 shows the effect of H₂O₂ concentration on the ratio of the total amount of organic carbon dissolved in the solution to the original carbon. As can be seen, increasing the concentration results in more solubilization. This can be attributed to radical formations which create more —COOH and —OH functional groups. These functional groups can be ideal landing sites for K+ coming from KOH which in turn can result in more solubilization. It is also not advisable to increase the concentration of H₂O₂ to high levels since this could create an acidic environment. An acidic environment will reduce the solubilization of humic acids in the solution causing it to precipitate with the residue.

During ultrasonic processing, sonication results in radical formation [47,48]. The reaction chains that happen are as follows (US: ultrasonic):

H₂O+US→·OH+·H (3)

·OH+·H→H₂O (4)

·OH+·OH→H₂O₂ (5)

·H+·H→H₂ (6)

When ultrasonic is coupled with H₂O₂, radical formations increase resulting in more ·OH attacks on the lignite molecule. The coupling of the ultrasonic and H₂O₂ resulted in reduction in the dosage of H₂O₂ utilized in this study. Mae et al. reported the use of H₂O₂ to obtain valuable chemicals from low-rank coals [33]. They were using 30% dosages compared to 3% used in this study. Fong et al. also reported higher dosages of H₂O₂ as optimum for extraction of humic acids from low-rank coals when used individually [49]. Using ultrasonic and H₂O₂ has been deemed successful by multiple researchers [50-52]. The decomposition of H₂O₂ under ultrasonic can follow the following equation [53-55]:

H₂O₂+US→·OH+·OH (7)

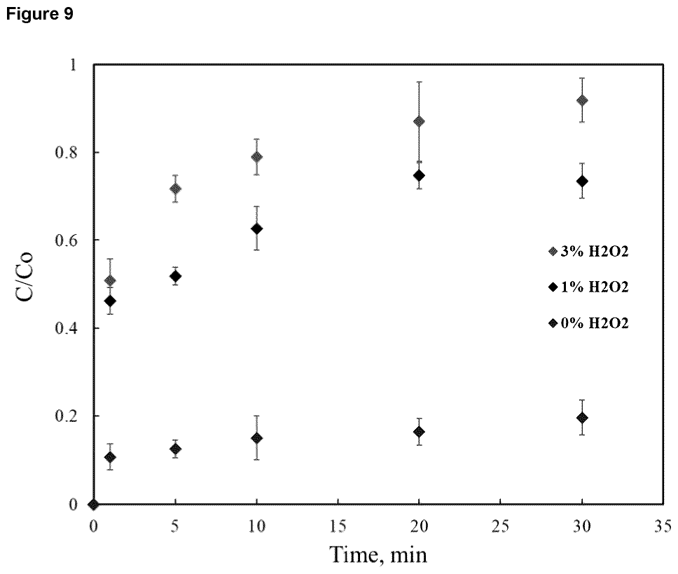

FIG. 9 shows the proposed mechanism of the formed ·OH radicals formed under ultrasonic processing from H₂O₂ and how they attack several sites on the lignite molecule. As shown, the ·OH radicals simultaneously broke the weak bonds and introduced —COOH and —OH groups into the molecules. The introduction of these groups has been confirmed using FTIR characterization in the next section. Mae et al. investigated the breakage of some weak covalent bonds and the introduction of oxygen functional groups during the treatment of coals with H₂O₂[56,57]. They reported that the amounts of COOH, O-aliphatic (including R—OH), and aliphatic carbon increased.

### Effect of KOH to Lignite Ratio and Alkaline Type

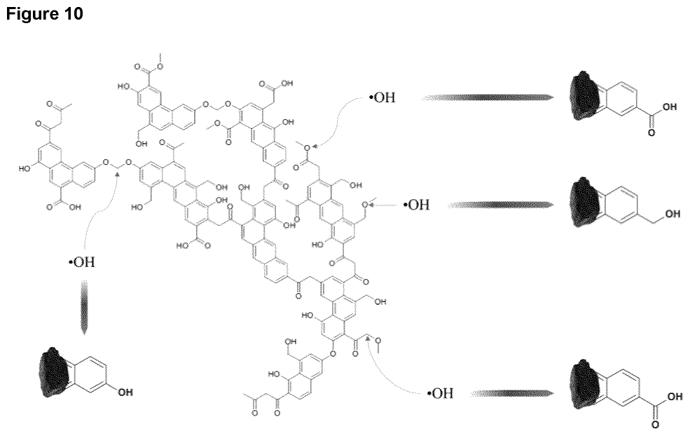

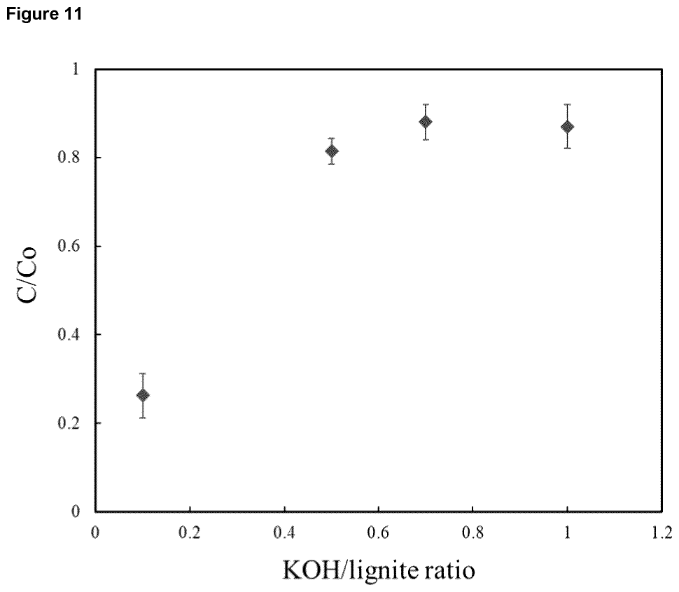

KOH plays an important role in solubilizing the humic substance from lignite. In order for humic substance to solubilize, an alkaline medium has to be achieved by adding any type of base. This can help to protect the intermediates and products by neutralizing the formed acids, therefore pulling these acids into the water [59-61]. In that sense, KOH allows for the protection of humic acids from deep oxidation to carbon dioxide. Kapo et al. [62] realized that increasing the concentration of NaOH resulted in reduction of CO₂ released during the production of organic acid from coal. KOH can also cause saponification reaction where certain functional groups such as esters can be cleaved to carboxylic and alcohol groups [171]. Adding a base can further help with reducing corrosion in the vessels during the reaction. Several researchers utilized different types of bases at different ratios [10,63]. Here, we reported the following ratios of KOH to lignite: 1:1, 0.7:1, 0.5:1 and 0.1:1 on mass basis. FIG. 10 shows the trend of C/Co ratio at different amounts of KOH with reaction time of 20 min, 40% amplitude, 3% H₂O₂. It does seem that lower than 0.7:1 ratio, the amount of solubilization decreased. At lower than 0.7:1, not enough K⁺ are generated for the solubilization of humic acid to happen [11,38,62,64]. Worth noting here that reducing the amount of KOH used is important from the economical point of view and that higher amounts of KOH can cause salting-out which can reduce the diffusion rate of the humic acids formed on the lignite surface into the water phase [62,65]. However, the potassium coming from the KOH is beneficial in the final products since it is one of the nutrients required for plants if the produced humic acids are used as fertilizers.

Various bases have been used in the literature and commercially. For that reason, NH₄OH has been tested specifically to incorporate nitrogen in the final products (humic acids) since nitrogen is one of the most important nutrients given to plants. First, NH₄OH was used to replace KOH and then a mixture of both was utilized. The degree of solubilization and the amount of nitrogen in the final product were investigated. FIG. 11 shows the effect of the type of alkaline on the solubilization and the nitrogen content. The amount of solubilized carbon decreased from over 80% to 60% when using NH₄OH as a replacement to KOH. This can be attributed to the fact that NH₄OH is a weak base. The exchange between NH⁴⁺ and H⁺ in —COOH and —OH is weaker, resulting in more NH⁴⁺ stability in the solution with less deprotonation [66,67]. When looking at solubilization and amount of nitrogen, it seems that using 50:50 (based on molarity) is favourable as it did not impact the solubilization and increase the amount of nitrogen from less than 1% to over 7%.

### Effect of Water to Lignite Ratio

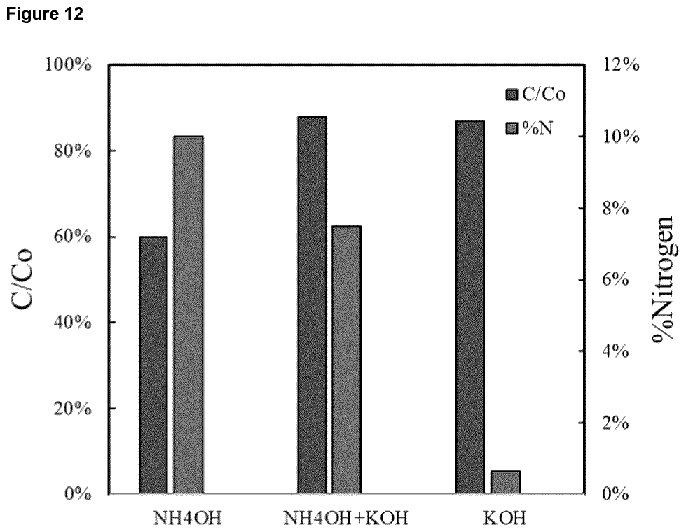

Water is the medium where the reaction happens, and all humic substances released from lignite are transferred to the water. The optimum amount of lignite to water had to be found to reduce water consumption. In this work, several ratios of lignite to water have been tested to find if the water ratio has an impact on the quantity of humic substances extracted. The experiments started with 20 mL water and 1 g lignite. In subsequent experiments, the amount of lignite has been increased to 1.5, 2 and 3 g while keeping the volume of water constant. At each experiment, the reaction conversion was calculated to conclude the optimum ratio of lignite to water in ultrasonic reactor. Reducing the amount of water required for each gram of lignite is going to make the process not only economical but also environmentally friendly. In order to reduce the quantity of water used in the process, we have tested various initial concentrations of lignite: 1, 1.3, 1.5, 2 and 3 g in 20 mL of water to examine the impact on the solubilization of organic carbon. FIG. 12 shows the effect of the initial concentration of lignite on the solubilization of carbon in water keeping water content constant at 20 mL while varying the lignite amount. Other parameters were constant at 40% amplitude, 3% H₂O₂ and 1:1 KOH/lignite ratio based on the optimization in this study. There is a trend of reduction specifically above 2 g lignite to 20 mL of water. This can be attributed to the saturation of water with lignite and KOH where no more carbon can be release to water after this ratio. It is typically referred to as salting-out effects. Schnitzer et al. reported the salting out effect during humic acid extraction from soils and Kapo and Wang from lignite and coals [62,68,69].

### Ultrasonic Reaction for Oxidized Coals and Peat

The ultrasonic reaction was conducted for Peat and different types of oxidized coals, namely; sub-bituminous, humalite, and leonardite. These coals were processed at the optimized reaction conditions to evaluate the capability of ultrasonic reaction to produce high yield of humic acids. The reactions were carried out at 40% ultrasonic amplitude, 0.5:1 KOH to feedstock ratio, and 3% H₂O₂. The results showed that the yield of humic acids conversion from these oxidized coals was high similar to the one obtained from lignite coal. These results can be explained by the fact that these types of coals have more or less similar content of oxygen (more than 20%), where the only different is the amount of ash content. Therefore, the yield of produced humic acids were in the order of sub-bituminous (90%)>leonardite were (85%), >humalite (80%). Peat has higher amount of ash and lower amount of oxygen compared to the oxidized coals and therefore, conversion was in the order of 30%

### Other Feedstocks (Petcoke, Biochar and Asphaltene)

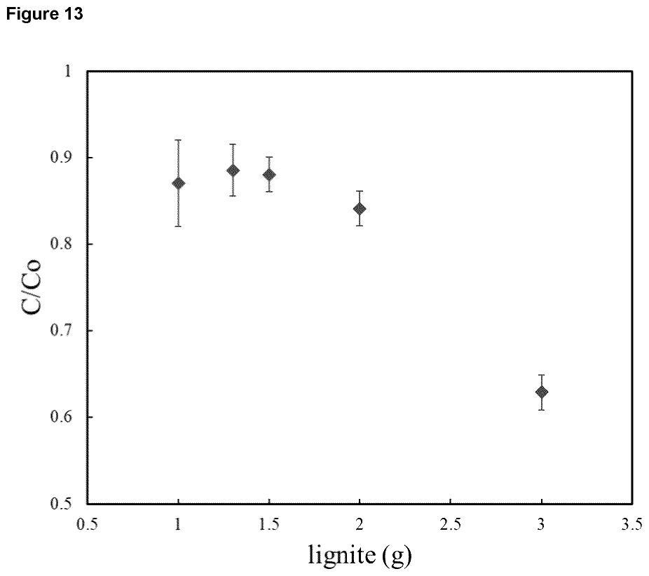

After screening the effect of ultrasonic reaction conditions on converting the lignite into humic acids, the ultrasonic process was also applied to other residual feedstocks including biochar, asphaltenes and petcoke. FIG. 13 shows that the process was successful to a certain extent in solubilizing carbon from the residual feedstocks. The reactions were carried out at 80% ultrasonic amplitude, 1:1 KOH to feedstock ratio, and 5% H₂O₂. While the chemical structures of biochar, petcoke and asphaltene differ from lignite, it is believed the ultrasonic processing introduces the same mechanism of converting the feedstock into organic acids.

### Characterization of Materials

In this section, detailed characterization of lignite, humic acids, and the residue left after the reaction is performed. These include FTIR, TGA and elemental analysis.

### FTIR of Lignite, Humic Acids and Residues

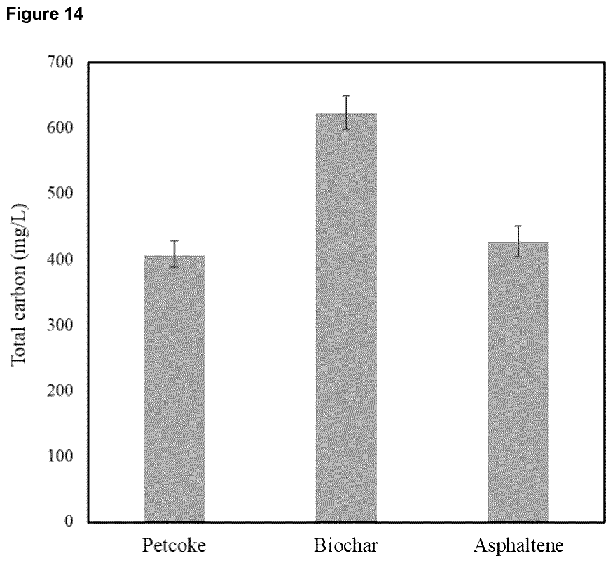

Fourier-transform infrared spectroscopy is the most reported method used in the literature to analyze humic acids. FTIR was used to determine the functional groups that might exist specifically oxygen containing functional groups. FIG. 14 shows the spectra for lignite obtained from Ward's Science as is without treatment, residue (the non-soluble part left after the reaction) and humic acids obtained from lignite after 20 min reaction time, 40% amplitude, 3% H₂O₂ and 1:1 lignite to KOH ratio. As shown in the region of 3600 to 2750 cm⁻¹, the humic acids spectra have strong and broad absorption bands compared to the residue and lignite. This band can be attributed to the hydrogen bond associated with —OH stretching or —NH stretching vibration absorption peaks in phenolic and carboxylic acid structures [70,71]. This band appears in the three spectra of lignite, humic acids, and residue; however, they are stronger in the humic acids' spectra. Manasrah et al. [189] have obtained similar bands from oxy-cracking petroleum coke to humic acids. Similar results have been found on lignite humic acids by Wang et al. [37]. The bands from 2000 to 1000 cm⁻¹ range can be attributed to the oxygen-containing functional groups in the humic acids. The band at 1700 cm⁻¹ represented the sharp C═O stretching vibration band of carboxylic acids, aldehydes, and ketones [21,72]. The band is clearly stronger in the humic acids' spectra than in the lignite and the residue. The small band at around 1570 cm⁻¹ can be attributed to COO-symmetric stretching that appears in the lignite and the residue but not the humic acids' spectra [73]. This could be an indication of the protonation happening in the humic acids [74]. Absorption near 1400 cm⁻¹ is probably due to OH deformation and C═O stretching of phenolic OH groups or C—H deformation of CH₂ and CH₃ groups [73-76]. The band observed at 1200 cm⁻¹ can be assigned to the —COO ester group, C═O stretching of phenols and ethers, C—OH deformation [71,77]. Overall, there is a clear difference between the spectra of humic acids and lignite which indicates that there is larger incorporation of oxygen containing functional groups such as —COOH and —OH and minor amounts of aldehyde, ketones and esters are formed during the ultrasonic processing of lignite. These functional groups are a clear indication of humic acids formation as reported by multiple studies analyzing humic acids from various sources [21,70,78-81]. On the other hand, the residue left after the reaction exhibit similar spectra of lignite.

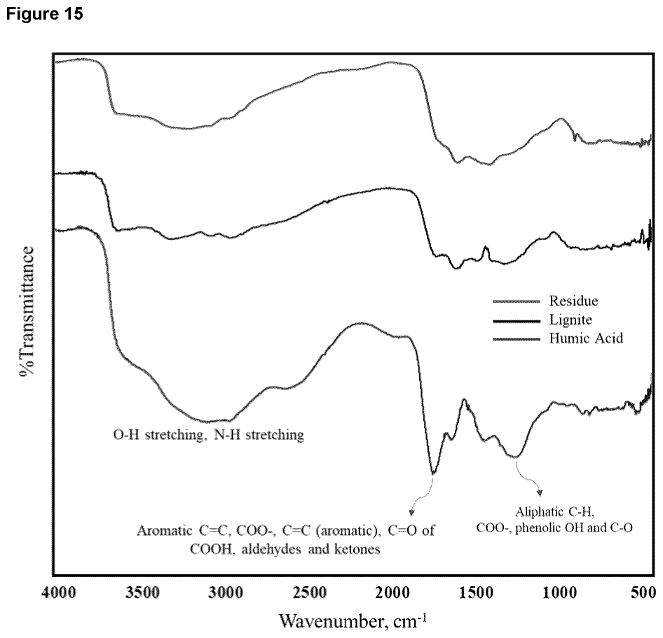

Furthermore, we looked at the difference and intensity in spectra of humic acid extracted using KOH versus the one extracted using NH₄OH. FIG. 15 shows the two spectra of humic acids extracted using KOH (humic acids K) and humic acids extracted using NH₄OH (humic acids N). The two spectra share similar bands such as —OH stretching around 3300 cm⁻¹ and carboxylic —COOH at 1700 cm⁻¹. However, the intensity at 1700 cm⁻¹ is higher on humic acid K compared to humic acids N as an indication of more carboxylic groups —COOH in the humic acids extracted using KOH. This can be an indication of less carboxylation when using NH₄OH as was seen also from the low solubility in the TOC results in this study. The intensity of the band around 2100 cm⁻¹ is higher in humic acids N compared to humic acids K which could be an indication of —N═C═O, —N═C═N—, or —N₃. The strong peak around 1400 cm⁻¹ can be assigned to NO₂ stretch [82,83]. Overall, this shows incorporation of nitrogen in the structure of humic acids as was also confirmed using CHN analyzer in this study. However, it is also noticed that the nitration and incorporating of nitrogen in humic acids can result at the expense of carboxylic groups. It is nevertheless important to incorporate nitrogen in the humic acids structure since nitrogen is an essential nutrient for plants [84].

### Thermogravimetric Analysis (TGA)

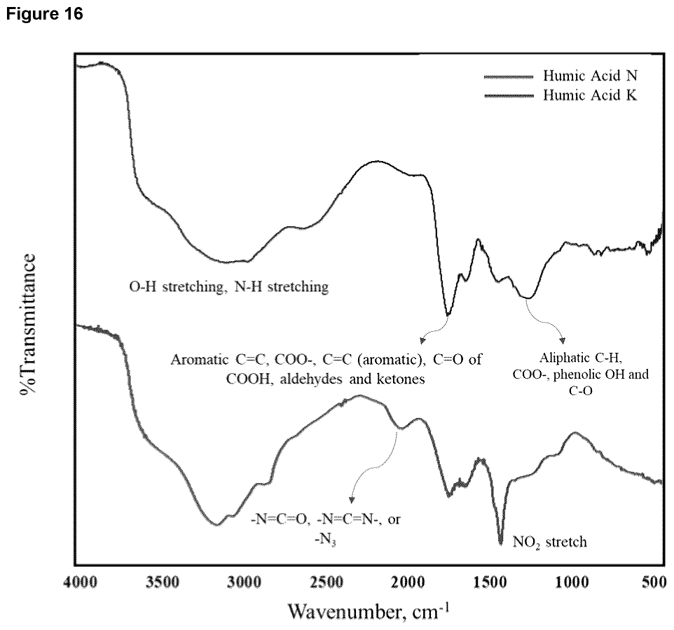

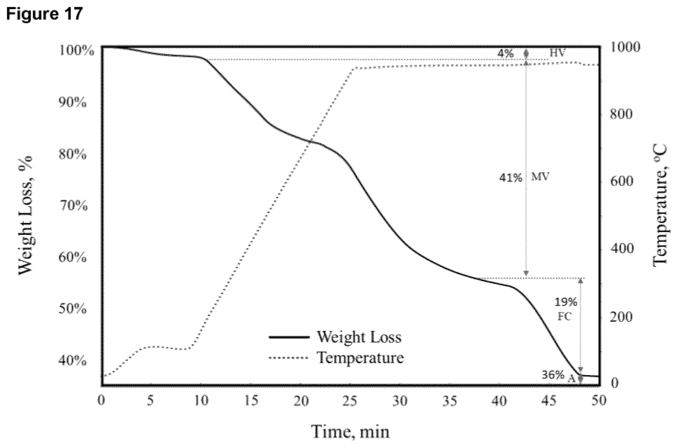

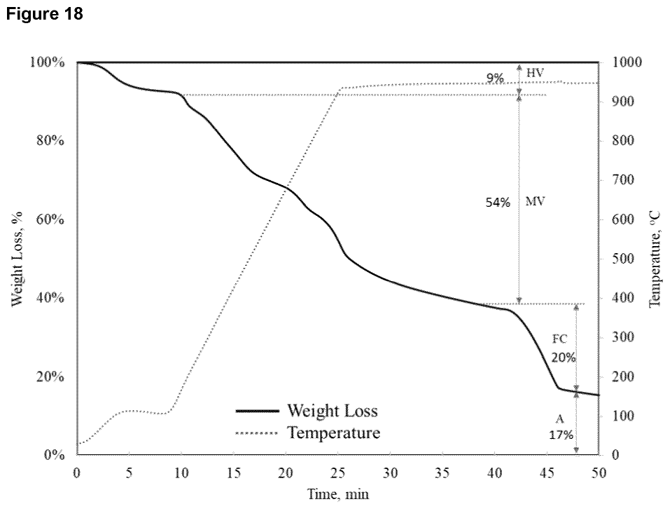

TGA was used to examine the physical characteristic of formed humic acids, lignite and residual lignite according to ASTM E1131 Standards. This analysis is typically referred to as proximate analysis for the determination of (1) high volatile matter, including moisture, plasticizers and other low boiling components. This step is achieved through heating to 110° C. and holding for 10 min under N₂; (2) medium volatile matter, which consists of gases and vapors released during the pyrolysis. Step 2 is achieved through heating from 110° C. to 950° C. and holding isothermally to drive off all volatile components; (3) fixed carbon, the non-volatile fraction of the material. Here, the gas is shifted to air and temperature is held at 950° C. until no change in weight is observed; (4) ash, the inorganic residue remaining after combustion. FIG. 16 shows an example of TGA analysis of formed humic acids. Humic acids are referred to as hygroscopic materials that like to adsorb moisture a lot. Therefore, extreme care was taken to reduce the exposure time of humic acids to air. Ash was determined to calculate the ash-free weight of humic acids as required by the standard quantification method (ISO 19822). It should be noted that the ash in humic acid most likely consists mainly of potassium which is a nutrient required for plants. The ISO 19822 requires the removal of ash since some extraction techniques utilize NaOH or other bases that do not contribute to soil and plant health. FIGS. 17 and 18 show the thermograms for the residue obtained after the reaction and the original lignite, respectively. The high volatiles, medium volatiles, fixed carbon, and ash were obtained from these thermograms and reported in Table 1. The amount of ash is clearly higher in produced humic acids compared to lignite, this is attributed to the potassium coming from the KOH used in the reaction. The first stage up to 110° C. corresponds to the evaporation of water incorporated in or adsorbed onto the formed humic acid, residue, and lignite. The loss, thereafter, under N₂ can be attributed to the loss of aliphatic moieties and polar functional groups in humic acid. Schnitzer et al. showed that phenolic OH and COOH groups were eliminated at 250° C. and 400° C. [85]. Campanella et al. found that decarboxylation and unsaturation losses occur at about 280° C. for humic substances [86]. Fixed carbon was observed to be lower in produced humic acids than raw lignite. This can be attributed to higher alkyl-aromatic, and poly-aromatic compounds [87].

The mass loss happens first in two stages dehydration and pyrolysis in N₂ atmosphere. These losses are related to moisture and volatile matter. The last stage is the decomposition happening in an air atmosphere and carried forward until only inorganics are left.

TABLE 1
Proximate Analysis of two samples of humic acids, lignite,
and residue as a percentage (Conditions: 20 mins reaction time, (Humic
Acid #1 at 3% H₂O₂, Humic Acid #2 at 1% H₂O₂),
40% amplitude, 1:1 KOH to lignite ratio)

| | High | Medium | | |
|---|---|---|---|---|
| | Volatile | Volatiles | Fixed | |
| Materials | matter | Materials | Carbon | Ash |
| Lignite | 9% | 38% | 42% | 11% |
| Humic Acid 1 | 4% | 41% | 19% | 36% |
| Humic Acid 2 | 9% | 35% | 22% | 34% |
| Residue | 9% | 54% | 20% | 17% |

### Elemental Analysis

Elemental analysis is used to determine carbon, hydrogen and nitrogen contents. The results were used for the kinetics modeling. Table 2 shows the % carbon, % hydrogen and % nitrogen of two humic acids samples and two residue samples obtained after 20 min reaction time, 1:1 KOH/lignite ratio, 40% amplitude with 3% and 1% H₂O₂ respectively. It is clear that the amount of hydrogen in humic acids is low indicating that these are more aromatic in nature. It has been found that samples exhibit a low H/C ratio also exhibit a high aromatic content and vice versa [88]. Less hydrogen can also be an indication of more oxygen been incorporated into the structure of the humic acid.

TABLE 2
Elemental analysis for selected humic acids samples and
residual samples as well (Conditions: 20 mins reaction time, (Humic
Acid #1 at 3% H₂O₂, Humic Acid# 2 at 1% H₂O₂),
40% amplitude, 1:1 KOH to lignite ratio)

| Materials | % C | % H | % N |
|---|---|---|---|
| Humic Acids 1 | 31 | 2.1 | 0.54 |
| Humic Acids 2 | 29 | 1.9 | 0.65 |
| Residue 1 | 40 | 3.1 | 0.53 |
| Residue 2 | 32 | 2.2 | 0.57 |

### Modeling of Ultrasonic Reaction

This section presents the results obtained after modeling the reaction using the power law and Arrhenius equation. The objective of the kinetics model is to understand the concentration profiles under various temperatures and later the results will be used to build a continuous reactor setup.

### Reaction Kinetic Model

During the ultrasonic processing of lignite, H₂O₂ decomposes into ·OH radicals. These radicals attack the lignite molecule. The ultrasonic processing results in more radicals formed as has been investigated before [53,55,89,90]. The formed radicals attack the lignite molecule on various sites creating more carboxylic and phenolic functional groups and breaking some of the bridges between aromatic clusters and aliphatic cross-links. This results in forming acids (desired products) namely humic acids. The characterization of these materials in this study confirmed the formation of humic acids. The humic acids were solubilized in water with the help of KOH. This solubilization minimizes the further oxidation of humic acids into CO₂. Humic acids, fulvic acids and other smaller acids may also be part of the solubilized materials. All solubilized materials were measured using TOC, and the TOC measurements were used to represent the organic solubilized materials. It is important to note that lignite molecule is too complex and there might be multiple steps of reactions involved, however, the following lumped kinetics model can serve as a first step into understanding the complex nature of the reactions involved. The concentration profiles were plotted against time for three average temperatures of 310 K, 315 K, and 322 K. The following model was used to explain the reaction happening during the process at the three specified temperatures as the concentrations change with time. Lignite (A) is converted to soluble materials (B). At operating temperatures lower than 333 K, it is assumed that none to minimal CO₂ is formed during the reaction. The kinetics model will allow for the observation of the effect of temperature and time on the degree of solubilization and conversion. The following lumped generalized kinetic model for reaction was adopted:

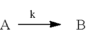

The kinetics rate equations are as follows:

$$\frac{{dC}_{A}}{dt} = - {r}_{A} = {kC}_{A}^{n} \qquad ( 8 )$$

$$\frac{{dC}_{B}}{dt} = {r}_{B} = {kC}_{A}^{n} \qquad ( 9 )$$

where C_{A} is the concentration of lignite at a certain time, t, C_{B} is the concentration of dissolved carbon at certain time, t, measuring using TOC. k is rate constant and n is the reaction order. The concentration of lignite at a certain time, t, was calculated using the following equations:

$${C}_{A} = ( 1 - X ) {C}_{A 0} \qquad ( 10 )$$

$$X = \frac{{C}_{A 0} - {C}_{R}}{{C}_{A 0}} \qquad ( 11 )$$

where C_{A0} is the carbon concentration of raw lignite before the reaction, C_{R} is the residual carbon concentration (unreacted lignite) that remains after the reaction. To solve the differential equations, initial conditions must be set as the following: at t=0, C_{A}=C_{A0} and C_{B}=0. C_{A0} is taken as the amount of carbon originally in lignite. As the reaction order was found experimental to be unity through fitting the concentration against time, n=1 was used in the equations above. The equations were solved to minimize the sum of the square of errors and from each temperature, a k value was obtained. Using the k values, the activation energy and pre-exponential factor can be determined graphically using the Arrhenius equation as follows:

$${k}_{i} = {A}_{i} {e}^{\frac{- {E}_{ai}}{{RT}_{i}}} \qquad ( 12 )$$

where A is the pre-exponential or frequency factor, Eₐ is the activation energy, R is the ideal gas constant, and T is the average temperature in Kelvin.

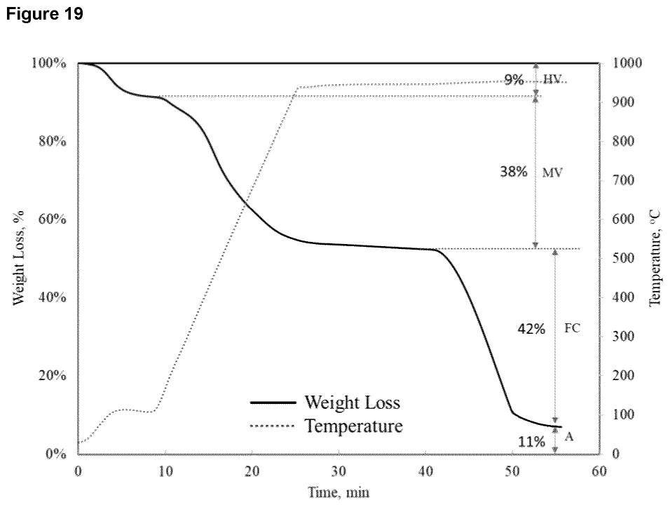

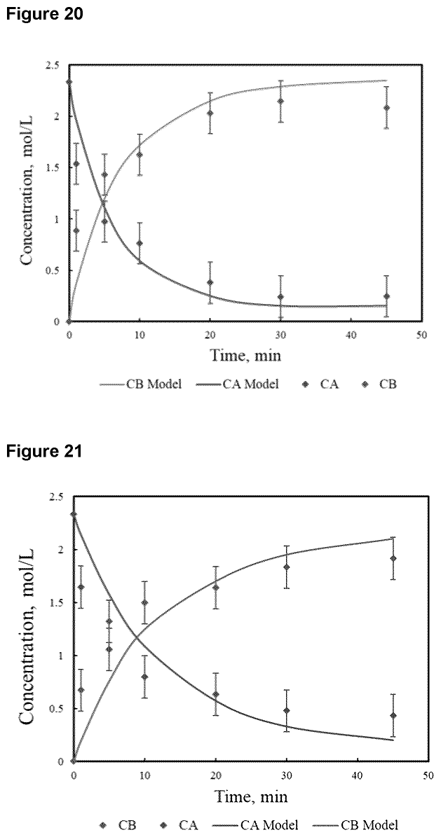

The kinetics experimental data were collected at three different temperatures of 310, 315, and 322 K and reaction times varying from 0 to 45 min. The concentration profiles of C_{A} and C_{B} were plotted against time at three different temperatures. The model fit well to the experimental data and the k values were calculated from each temperature profile in FIGS. 19, 20, and 21. The reaction temperature is a key parameter in ultrasonic process. At higher temperatures (higher ultrasonic amplitude), the solubilization of organic acids in water is increased and achieved the maximum concentration faster than at lower temperatures.

The fitting for first order reaction resulted in more linear trend, indicating the reaction can be assumed to be first order. The following equation are solved simultaneously using MATLAB to minimize the error:

$$\frac{{dC}_{A}}{dt} = - {r}_{A} = {kC}_{A}^{1} \qquad ( 13 )$$

$$\frac{{dC}_{B}}{dt} = {r}_{B} = {kC}_{A}^{1} \qquad ( 14 )$$

Equation 8 becomes:

$${dC}_{A} = - {r}_{A} = {kC}_{A}^{1} * dt \qquad ( 15 )$$

Integration happens from t=0 to t=45 and C_{A0}=2.3. The same thing would happen for equation 9 for C_{B}.

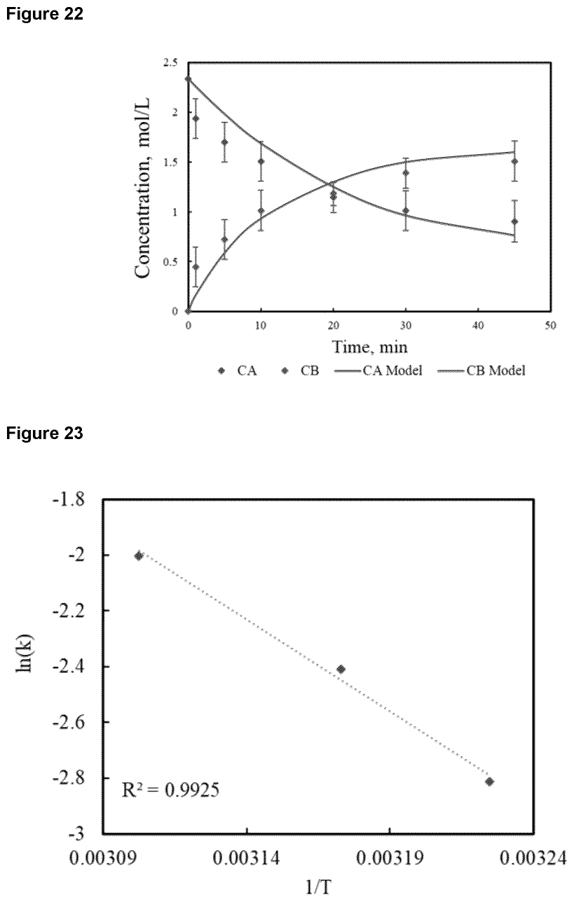

FIG. 22 represents the Arrhenius plot of lignite ultrasonic reaction at three different reaction temperatures. Plotting ln(k) against 1/T gave a good fit between the Arrhenius equation and the experimental data, indicated by R² value of 0.99. From the slope and intercept of the best-fit-line, the values of activation energy and frequency factors were calculated and summarized in Table 3. Several researchers reported the conversion of lignite and coals to organic acids under mild temperatures but there is a lack of data on the influence of ultrasonic processing on the reaction. Kelemen et al. reported the mild oxidation of coal having an activation energy of 48 kJ/mol, and this is not far from what is reported in this study (54 kJ/mol) [91]. Lee et al. reported activation energies ranging from 9 to 66 kJ/mol [92]. The differences can be attributed to the type of coal utilized in the study and the use of ultrasonic processing. Ultrasonic processing can result in higher mass transfer which in turn can increase the rate of reaction [93-96].

TABLE 3
Kinetics parameters obtained from the modeling.

| | Temperature | Eₐ | |
|---|---|---|---|
| k (s⁻¹) | (K) | (kJ/mol) | A (s⁻¹) |
| 6.173 × 10⁻² | 310 | 54.7 | 6.5 × 10⁷ |
| 9.237 × 10⁻² | 315 | | |
| 13.53 × 10⁻² | 322 | | |

### Ultrasonic Continuous Processing

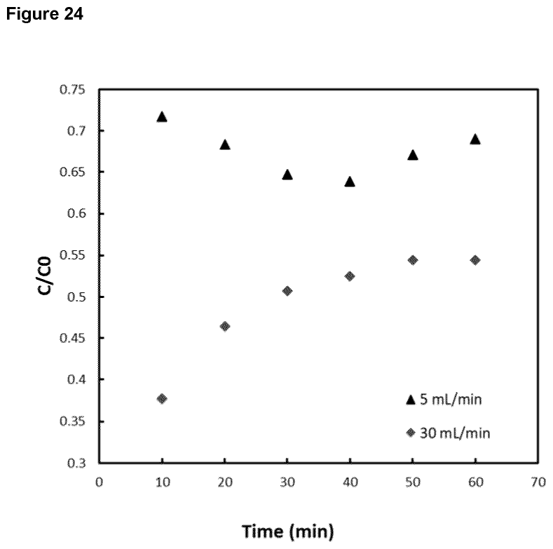

Testing the ultrasonic process in the continuous mode showed promising results. Based on the flow rates, the conversion increased at slower rates which can be explained by residence times. At lower flow rates molecules spend more time in the reactor which in turn increase the conversion. After longer times, we can see signs of stabilization. FIG. 23 shows the conversion results (C/Co) of humic acids from lignite coal at two flow rates obtained during the testing of the continuous mode at the optimized reaction conditions. Where C is the carbon content in the produced humic acids and Co is the carbon content in the virgin materials (feed).

### CONCLUSION

As disclosed herein, ultrasonic processing may be carried out so as to improve the yield and reduce the time of converting low-rank coal-lignite, oxidized coal,), Peat and petcoke, biochar and asphaltenes to humic substance (both humic acids and fulvic acids). The Examples illustrate various aspects of the process experimentally and theoretically through kinetics modeling. Experimentally, the effects of varying several parameters are illustrated, including ultrasonic amplitude, reaction time, alkaline concentration and type, initial concentration of lignite and the dosage of H₂O₂. The ultrasonic processing was carried out on samples of lignite weighing 1 to 3 g in 20 mL water. Reaction time was varied from 1 to 45 min. Dosage of H₂O₂ was tested at 0% to 3%. Alkaline amounts from 0.1 to 1 were tested with two bases, potassium hydroxide and ammonium hydroxide. After each example, residual materials were collected, and total organic carbon was measured for liquid portion. Humic acids were then extracted from liquid portion and analyzed with FT-IR, elemental analysis and TGA. Residual materials were also analyzed using FT-IR, elemental analysis and TGA. It was observed that as the reaction time increased, the reaction conversion and yield of HA increased as well. The same trend was observed with H₂O₂ concentration and the ultrasonic amplitude. In select embodiments, optimum parameters for the highest yield of humic acids from lignite were: 40% ultrasonic amplitude, 1:1 KOH to lignite ratio, 30 mins reaction time, and 3% H₂O₂. Strong bases such as KOH are more favourable, however, mixing two bases such as KOH and NH₄OH has been deemed beneficial because it increased the amount of nitrogen in the final products as nitrogen is an important nutrient for plants in case the humic acids were to be used as a fertilizer. The technology has achieved solubilization of carbon of above 90% and yield of ash-free humic acids of 72% for lignite. The internationally recognized method (ISO 19822) was used for the quantification of humic acids to calculate the yield. The characterization of the produced humic acids showed successful incorporation of oxygen functional groups specifically COOH and OH into the final products. Reaction kinetics modeling was done to investigate how concentration profiles change with temperature and time and to calculate the kinetics parameters, reaction constants, activation energy and pre-exponential factor. Three temperatures were used 310, 315, and 322 K. The reaction constant values were, 6.173×10⁻², 9.237×10⁻², 13.53×10⁻² (s⁻¹). Activation energy and pre-exponential factor were calculated to be: 54.7 (kJ/mol.) and 6.5×10⁷ (s⁻¹), respectively. It was determined experimentally that the reaction is first-order reaction. The kinetics modeling helped with constructing a reaction mechanism scheme where ·OH radicals produced through ultrasonic attack the lignite molecule at various sites breaking weak bonds and creating —OH and —COOH functional groups. The kinetics model is provided herein to facilitate operation of a continuous process. This Example accordingly illustrates the use of ultrasonic processing to reduce time and improve yield of humic acids from low-rank coals, oxidized coals, petcoke, biochar and asphaltenes through increasing radical formation and improving mass transfer.

### Nomenclature

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

| Symbol or | |
|---|---|
| abbreviation | Definition |
| A | Pre-exponential factor |
| C | Concentration |
| C_{A} | Concentration of lignite after the reaction |
| C_{Ao} | Initial concentration of carbon in lignite |
| CAGR | Compound Annual Growth Rate |
| C_{B} | Concentration of organics in the solution |
| CHN | Carbon, hydrogen, and nitrogen |
| Eₐ | Activation energy |
| FA | Fulvic Acid |
| FTIR | Fourier-transform infrared spectroscopy |
| GHG | Greenhouse Gases |
| HA | Humic Acids |
| HS | Humic Substance |
| IC | Inorganic carbon |
| ISO | International Organization for Standardization |
| K | Rate constant |
| kHz | Kilohertz |
| Mt | Mega tonnes |
| n | Reaction order |
| R | Universal gas constant. |
| T | Temperature |
| t | Time |
| TC | Total carbon |
| TGA | Thermogravimetric Analysis |
| TOC | Total organic carbon |

### REFERENCES

[1] Bekele A, Roy J L, Young M A. Use of biochar and oxidized lignite for reconstructing functioning agronomic topsoil: Effects on soil properties in a greenhouse study. Can J Soil Sci 2015; 95:269-85. https://doi.org/10.4141/CJSS-2014-008.
[2] Caenn R, Darley† H C H, Gray† G R. Introduction to Drilling Fluids. Compos. Prop. Drill. Complet. Fluids, Elsevier; 2017, p. 1-34. https://doi.org/10.1016/b978-0-12-8047514.000-01-8.
[3] Electric Power|The Canadian Encyclopedia n.d. https://www.the canadian encyclopedia-.ca/en/article/electric-power (accessed Jun. 1, 2021).
[4] Coal phase-out: the Powering Past Coal Alliance—Canada.ca n.d. https://www.canada-.ca/en/services/environment/weather/climatechange/canada-international-action/coal-phase-out.html (accessed Feb. 26, 2021).
[5] Liem, E. L, Low-Rank Coal Applications in Agriculture: Humic Analyses, Products, and Performance|Wiley, 2021
[6] Jeong H J, Cha J-Y, Jung I I, Choi H, Jang K-S, Lim J, et al. One-Pot Transformation of Technical Lignins into Humic-Like Plant Stimulants through Fenton-Based Advanced Oxidation: Accelerating Natural Fungus-Driven Humification 2018. https://doi.org/1-0.1021/acsomega.8b00697.
[7] Deiana S., Gessa C, Manunza B., Rausa R, Seeber R. Analytical and spectroscopic characterization of humic acids . . . : soil science. Soil sci 1990:419-24.
[8] Haworth r. D. The chemical nature of humic acid. Soil sci 1971; 111:71-9.
[9] Proidakov A G. Humic Acids from Mechanically Treated Coals: A Review. Solid Fuel Chem 2009.
[10] Garcia D, Cegarra J, Abad M. A comparison between alkaline and decomplexing reagents to extract humic acids from low rank coals. Fuel Process Technol 1996; 48:51-60. https://doi.org/10.1016/0378-3820(96)01025-9.
[11] Huey L J, Ahmed O H, Nik N M. Effects of extractants on the yields and selected chemical characteristics of humic acids isolated from tropical saprists peat. Am J Appl Sci 2010; 7:920-3. https://doi.org/10.3844/ajassp.2010.933.936.
[12] Youngs R, Frost C. Humic acids from leonardite: a soil conditioner and organic fertilizer. Am Chem Soc, Div Fuel Chem, Prepr; (United States) 1963.
[13] Frost C M, Hoeppner J J, Fowkes W W. Source and Some General Properties of Humic Acids from Lignitic Materials. J Chem Eng Data 1959; 4:173-6. https://doi.org/10.1021/je60002-a018.
[14] Isolation of IHSS Soil Fulvic and Humic Acids|IHSS n.d. http://humic-substances.org/isolation-of-ihss-soil-fulvic-and-humic-acids/(accessed Jan. 27, 2021).
[15] Thiessen G, Engelder C J. Isolation of the Humic Acids. Ind Eng Chem 1930; 22:1131-3. https://doi.org/10.1021/ie50250a031.
[16] Polansky T S, Kinney C R. Solvent Extraction of Humic Acids from Nitric Acid-Treated Bituminous Coal. Ind Eng Chem 1947. https://doi.org/10.1021/ie50451a027.
[17] Hayes M H B, Swift R S, Wardle R E, Brown J K. Humic materials from an organic soil: A comparison of extractants and of properties of extracts. Geoderma 1975. https://doi.-org/10.1016/0016-7061(75)90020-8.
[18] E Kurniati, S Muljani, D G Virgani B P N. Humic Acid Isolations from Lignite by Ion Exchange Method. J Phys 2018. https://doi.org/10.1088/1742-6596/953/1/012234.
[19] Li Yanhong, Zhang Yuanqin, Zi Changyu, Liang Guangbing, Zhang Dengfeng. Method for improving humic acid yield by thermal oxidation of lignite. C N110183682A, 2019.
[20] Cortés fb, Montoya T, Acevedo s, Nassar N N, Andrés Franco c. Adsorption-desorption of n-c 7 asphaltenes over micro- and nanoparticles of silica and its impact on wettability alteration adsorption-desorption of n-c 7 asphaltenes over micro- and nanoparticles of silica and its impact on wettability alteration. tecnol y futur 2016; 6:4. https://doi.org/10.29047/-01225383.06.
[21] Manasrah A D, Nassar N N, Ortega L C. Conversion of petroleum coke into valuable products using oxy-cracking technique. Fuel 2018; 215:865-78. https://doi.org/10.1016/j.fuel.2017.-11.103.
[22] Stevenson F. Humus Chemistry: Genesis, Composition, Reactions. Humus Chem 1994.
[23] Swift R S. Organic Matter Characterization, 2018. https://doi.org/10.2136/sssabookser-5.3.c35.
[24] ASTM E1131-20 Standard Test Method for Compositional Analysis by Thermogravimetry n.d. https://www.astm.org/Standards/E1131.htm (accessed Jun. 1, 2021).
[25] Stavarache C, Yim B, Vinatoru M, Maeda Y. Sonolysis of chlorobenzene in Fenton-type aqueous systems. Ultrason Sonochem 2002; 9:291-6. https://doi.org/10.1016/SI350-4177(02)00088-3.
[26] Curtin D, Beare M H, Chantigny M H, Greenfield L G. Controls on the Extractability of Soil Organic Matter in Water over the 20 to 80° C. Temperature Range. Soil Sci Soc Am J 2011; 75:1423-30. https://doi.org/10.2136/sssaj2010.0401.
[27] Kaiser K, Zech W. Competitive Sorption of Dissolved Organic Matter Fractions to Soils and Related Mineral Phases. Soil Sci Soc Am J 1997; 61:64-9. https://doi.org/10.2136/sssajl997.03615995006100010011x.
[28] Mohinuzzaman M, Yuan J, Yang X, Senesi N, Li S L, Ellam R M, et al. Insights into solubility of soil humic substances and their fluorescence characterisation in three characteristic soils. Sci Total Environ 2020; 720:137395. https://doi.org/10.1016/j.-scitotenv.2020.137395.
[29] Gamble D S. Na+ and K+ Binding by Fulvic Acid1. vol. 51. Ottawa: 1973.
[30] Gierer J, Yang E, Reitberger T. On the significance of the superoxide radical (O2-/HO2·) in oxidative delignification, studied with 4-t-butylsyringol and 4-t-butylguaiacol part i. the mechanism of aromatic ring opening. Holzforschung 1994; 48:405-14. https://doi.org/-10.1515/hfsg.1994.48.5.405.
[31] Gierer J. Formation and involvement of superoxide (O2·-/HO2·) and hydroxyl (OH·) radicals in TCF bleaching processes: A review. Holzforschung 1997; 51:34-46. https://doi.org/10.1515/hfsg.1997.51.1.34.
[32] Omori S, Dence C W. The reactions of alkaline hydrogen peroxide with lignin model dimers—Part 1: Phenacyl α-aryl ethers. Wood Sci Technol 1981; 15:67-79. https://doi.org/-10.1007/BF00366502.
[33] Mae K, Shindo H, Miura K. A New Two-Step Oxidative Degradation Method for Producing Valuable Chemicals from Low Rank Coals under Mild Conditions 2001. https://doi.org/10.1021/ef000177e.
[34] Haber F, Weiss J, Seph J O, Eiss W. The catalytic decomposition of hydrogen peroxide by iron salts. Proc R Soc London Ser A—Math Phys Sci 1934; 147:332-51. https://doi.org/10.1098/rspa.1934.0221.
[35] Baumstark A L. The Chemistry of Peroxides. J Am Chem Soc 2007; 129:450-1. https://doi.org/10.1021/ja069786c.
[36] Sim S F, Seng L, Wong N C, Asing J, Faizal B Md Nor M, Satirawaty Bt Mohd Pauzan A. Characterization of the coal derived humic acids from Mukah, Sarawak as soil conditioner. J Braz Chem Soc 2006. https://doi.org/l0.1590/sOl03-50532006000300023.
[37] Wang C-F, Fan X, Zhang F, Wang S-Z, Zhao Y-P, Zhao X-Y, et al. Characterization of humic acids extracted from a lignite and interpretation for the mass spectra †2017. https://doi.org/10.1039/c7ra01497j.
[38] Syahren A M, Wong N C. Extraction and chemical characteristics of nitro-humic acids from coals and composts (Pengekstrakan dan sifat kimia asid nitro-humik daripada arang batu dan kompos). vol. 36. 2008.
[39] Doskočil L, Grasset L, Válková D, Pekař M. Hydrogen peroxide oxidation of humic acids and lignite. Fuel 2014; 134:406-13. https://doi.org/10.1016/j.fuel.2014.06.011.
[40] Manasrah A D, Nassar N N. Enhanced production of humic acids from coal-lignite via water-oxygen systems, WO2021113978A1. 2019
[41] Oroian M, Ursachi F, Dranca F. Influence of ultrasonic amplitude, temperature, time and solvent concentration on bioactive compounds extraction from propolis. Ultrason Sonochem 2020; 64. https://doi.org/10.1016/j.ultsonch.2020.105021.
[42] Al-Dhabi N A, Ponmurugan K, Maran Jeganathan P. Development and validation of ultrasound-assisted solid-liquid extraction of phenolic compounds from waste spent coffee grounds. Ultrason Sonochem 2017; 34:206-13. https://doi.org/10.1016/j.ultsonch.2016.-05.005.
[43] Shojaeiarani J, Bajwa D, Holt G. Sonication amplitude and processing time influence the cellulose nanocrystals morphology and dispersion. Nanocomposites 2020; 6:41-6. https://doi.org/10.1080/20550324.2019.1710974.
[44] Kojima Y, Yamaguchi K, Nishimiya N. Effect of amplitude and frequency of ultrasonic irradiation on morphological characteristics control of calcium carbonate 2009. https://doi.org/10.1016/j.ultsonch.2009.10.020.
[45] Ebrahimi H, Karamoozian M. Effect of ultrasonic irradiation on particle size, reagents consumption, and feed ash content in coal flotation. Int J Coal Sci Technol 2020; 7:787-95. https://doi.org/10.1007/s40789-020-00307-2.
[46] Burek B O, Bormann S, Hollmann F, Bloh J Z, Holtmann D. Hydrogen peroxide driven biocatalysis. Green Chem 2019; 21:3232-49. https://doi.org/10.1039/c9gc00633h.
[47] Boffito D C, Crocella V, Pirola C, Neppolian B, Cerrato G, Ashokkumar M, et al. Ultrasonic enhancement of the acidity, surface area and free fatty acids esterification catalytic activity of sulphated ZrO2-TiO2 systems. J Catal 2013; 297:17-26. https://doi.org/10.-1016/j.jcat.2012.09.013.
[48] Yanagida H, Masubuchi Y, Minagawa K, Ogata T, Takimoto J I, Koyama K. A reaction kinetics model of water sonolysis in the presence of a spin-trap. Ultrason Sonochem 1999; 5:133-9. https://doi.org/10.1016/S1350-4177(98)00020-0.
[49] Sim S F, Seng L, Bt Majri N, Bt Mat H. A comparative evaluation on the oxidative approaches for extraction of humic acids from low rank coal of Mukah, Sarawak. J Braz Chem Soc 2007; 18:34-40. https://doi.org/10.1590/sOl03-50532007000100003.
[50] Yuan D, Zhou X, Jin W, Han W, Chi H, Ding W, et al. Effects of the Combined Utilization of Ultrasonic/Hydrogen Peroxide on Excess Sludge Destruction. Water 2021; 13:266. https://doi.org/10.3390/w13030266.
[51] Rahdar S, Igwegbe C A, Ghasemi M, Ahmadi S. Degradation of aniline by the combined process of ultrasound and hydrogen peroxide (US/H 2 O 2). MethodsX 2019; 6:492-9. https://doi.org/10.1016/j.mex.2019.02.033.
[52] Patil P N, Gogate P R. Degradation of dichlorvos using hybrid advanced oxidation processes based on ultrasound. J Water Process Eng 2015; 8:e58-65. https://doi.org/10.1016/j.jwpe.-2014.10.012.
[53] Mahamuni N N, Adewuyi Y G. Advanced oxidation processes (AOPs) involving ultrasound for waste water treatment: A review with emphasis on cost estimation. Ultrason Sonochem 2010; 17:990-1003. https://doi.org/10.1016/j.ultsonch.2009.09.005.
[54] Colmenares J C, Gregory Chatel, Ashokkumar M, Babu S G, Barge A, Bhangu S K, et al. Topics in Current Chemistry Collections Sonochemistry. 2017.
[55] Hua I, Hoffmann M R. Optimization of ultrasonic irradiation as an advanced oxidation technology. Environ Sci Technol 1997; 31:2237-43. https://doi.org/10.1021/es960717f.
[56] Mae K, Maki T, Araki J, Miura K. Extraction of Low-Rank Coals Oxidized with Hydrogen Peroxide in Conventionally Used Solvents at Room Temperature. 1997.
[57] Mae K, Inoue S, Miura K. Flash Pyrolysis of Coal Modified through Liquid Phase Oxidation and Solvent Swelling. 1996.
[58] Wang J, He Y, Li H, Yu J, Xie W, Wei H. The molecular structure of Inner Mongolia lignite utilizing XRD, solid state 13 C NMR, HRTEM and XPS techniques. Fuel 2017; 203:764-73. https://doi.org/10.1016/j.fuel.2017.05.042.
[59] Howard H C, Berman N. Water-soluble polycarboxylic acids from oxidation of bituminous coal. Anal Chem 1949; 21:1200-2. https://doi.org/10.1021/ac60034a014.
[60] Franke N W, Kiebler M W, Ruof C H, Savich T R, Howard H C. WATER-SOLUBLE POLYCARBOXYLIC ACIDS BY OXIDATION OF COAL. Ind Eng Chem 1952; 44:2784-92. https://doi.org/10.1021/ie50515a073.
[61] Montgomery R S, Sienknecht P J. Fractionation of Water-Soluble Acids Obtained by Alkali-Oxygen Oxidation of Coal. Ind Eng Chem 1955; 47:1274-6. https://doi.org/10.1021/ie50546a060.
[62] Kapo G, Calvert S. Liquid phase oxidation of coal in alkali. Ind Eng Chem Process Des Dev 1966; 5:97-104. https://doi.org/10.1021/i260017a021.
[63] Li Y, Yuan S. Influence of addition of KOH on the yield and characteristics of humic acids extracted from lignite using NaOH. SN Appl Sci 2021; 3:1-10. https://doi.org/10.1007/s42452-020-04087-x.
[64] Pang L S K, Vassallo A M, Wilson M A. Chemistry of alkali extraction of brown coals-I. Kinetics, characterisation and implications to coalification. Org Geochem 1990; 16:853-64. https://doi.org/10.1016/0146-6380(90)90122-G.
[65] Graziano G. On the salting out of benzene by alkali chlorides. J Chem Eng Data 2009; 54:464-7. https://doi.org/10.1021/je8004722.
[66] Coca J, Alvarez R, Fuertes A B. Production of a Nitrogenous Humic Fertilizer by the Oxidation-Ammoniation of Lignite. Ind Eng Chem Prod Res Dev 1984; 23:620-4. https://doi.org/10.1021/i300016a022.
[67] Nasir S, Sarfaraz T B, Verheyen T V, Chaffee A L. Structural elucidation of humic acids extracted from Pakistani lignite using spectroscopic and thermal degradative techniques 2011. https://doi.org/10.1016/j.fuproc.2010.12.020.
[68] Wang W, Hou Y, Wu W, Niu M, Wu T. High-temperature alkali-oxygen oxidation of lignite to produce benzene polycarboxylic acids. Ind Eng Chem Res 2013; 52:680-5. https://doi.org/10.1021/ie3029398.
[69] Schnitzer M. Humic-Fulvic Acid Relationship in Orgganic Solis and Humification of the Orgnaic Matter in these Soil; s'. Ottawa: 1967.
[70] Doskocil L, Burdfkove-Szewieczkove J, Enev V, Kalina L, Wasserbauer J. Spectral characterization and comparison of humic acids isolated from some European lignites. Fuel 2018. https://doi.org/10.1016/j.fuel.2017.10.114.
[71] Tatzber M, Stemmer M, Spiegel H, Katzlberger C, Haberhauer G, Mentler A, et al. FTIR-spectroscopic characterization of humic acids and humin fractions obtained by advanced NaOH, Na 4 P 2 O 7, and Na 2 CO 3 extraction procedures. J Plant Nutr Soil Sci 2007; 170:522-9. https://doi.org/10.1002/jpln.200622082.
[72] Xiao L, Li Y, Liao Y, Ma H, Wu J, Zhang Y, et al. Bioconversion of lignite humic acid by white-rot fungi and characterization of products. 3 Biotech 2018; 8:258. https://doi.org/10.1007/s13205-018-1281-4.
[73] Zhou L, Yuan L, Zhao B, Li Y, Lin Z. Structural characteristics of humic acids derived from Chinese weathered coal under different oxidizing conditions. PLoS One 2019; 14:e0217469. https://doi.org/10.1371/journal.pone.0217469.
[74] Boguta P, Sokolowska Z. Interactions of Zn(II) Ions with Humic Acids Isolated from Various Type of Soils. Effect of pH, Zn Concentrations and Humic Acids Chemical Properties. PLoS One 2016; 111:e0153626. https://doi.org/10.1371/journal.pone.0153626.
[75] Manasrah A D, El-Qanni A, Badran I, Carbognani Ortega L, Perez-Zurita M J, Nassar N N. Experimental and theoretical studies on oxy-cracking of Quinolin-65 as a model molecule for residual feedstocks. React Chem Eng 2017; 2:709-19. https://doi.org/10.1039/c7re00048k.
[76] Nassar, N. N., Manasrah, A. D. and Vitale, G., UTI L P. Demineralization and upgrading of petroleum cokes. U.S. Pat. No. 10,883,060. 2021 [77] Tinti A, Tugnoli V, Bonora S, Francioso O. Recent applications of vibrational mid-Infrared (IR) spectroscopy for studying soil components: a review n.d. https://doi.org/10.5513/JCEA01/16.1.1535.
[78] Ashtari M, Carbognani L, Pereira-Almao P. Asphaltenes Aqueous Conversion to Humic and Fulvic Analogs via Oxy-Cracking. Energy and Fuels 2016; 30:5470-82. https://doi.org/10.1021/acs.energyfuels.6b00613.
[79] Ibarra J V. Fourier transform infrared studies of coal humic acids. Sci Total Environ 1989; 81-82:121-8. https://doi.org/10.1016/0048-9697(89)90117-4.
[80] Jaing T, Han G H, Zhang Y B, Huang Y F, Li G H, Guo Y F, et al. Improving extraction yield of humic substances from lignite with anthraquinone in alkaline solution. J Cent South Univ Technol (English Ed 2011. https://doi.org/10.1007/s11771-011-0660-3.
[81] Zhou L, Yuan L, Zhao Id B, Li Y, Lin Z. Structural characteristics of humic acids derived from Chinese weathered coal under different oxidizing conditions 2019. https://doi.org/10.1371/journal.pone.0217469.
[82] De Mastro F, Cocozza C, Traversa A, Savy D, Abdelrahman H M, Brunetti G. Influence of crop rotation, tillage and fertilization on chemical and spectroscopic characteristics of humic acids. PLoS One 2019; 14:e0219099. https://doi.org/l0.1371/journal.pone.0219099.
[83] Dick D P, Mangrich A S, Menezes S M C, Pereira B F. Chemical and spectroscopical characterization of humic acids from two South Brazilian coals of different ranks. J Braz Chem Soc 2002; 13:177-82. https://doi.org/10.1590/SO103-50532002000200008.
[84] Li M, Hu H, He X, Jia J, Drosos M, Wang G, et al. Organic Carbon Sequestration in Soil Humic Substances As Affected by Application of Different Nitrogen Fertilizers in a Vegetable-Rotation Cropping System. J Agric Food Chem 2019; 67:3106-13. https://doi.org/10.1021/acs.jafc.8b07114.
[85] Schnitzer M, Hoffman I. Thermogravimetry of soil humic compounds. Geochim Cosmochim Acta 1965; 29:859-70. https://doi.org/10.1016/0016-7037(65)90083-9.
[86] Campanella L, Tomassetti M, Piccolo A. Thermogravimetric and IR analysis of different extracts of humic substances. Thermochim Acta 1990; 170:67-80. https://doi.org/10.-1016/0040-6031(90)80525-4.
[87] Saikia B K, Boruah R K, Gogoi P K, Baruah B P. A thermal investigation on coals from Assam (India). Fuel Process Technol 2009; 90:196-203. https://doi.org/10.1016/j.fuproc.-2008.09.007.
[88] Rice J A, MacCarthy P. Statistical evaluation of the elemental composition of humic substances. Org Geochem 1991; 17:635-48. https://doi.org/10.1016/0146-6380(91)90006-6.
[89] Barbier P F, Petrier C. Study at 20 kHz and 500 kHz of the Ultrasound-Ozone Advanced Oxidation System: 4-Nitrophenol Degradation. J Adv Oxid Technol 2017. https://doi.org/-10.1515/jaots-1996-0208.
[90] Miura K, Mae K, Okutsu H, Mizutani N A. New oxidative degradation method for producing fatty acids in high yields and high selectivity from low-rank coals. Energy and Fuels 1996; 10:1196-201. https://doi.org/10.1021/ef960051a.
[91] Kelemen S R, Freund H. Oxidation Kinetics of Illinois No. 6 Coal in Air between 295 and 398 K. vol. 3. 1989.
[92] Lee D G, Isworo Y Y, Park K H, Kim G M, Kim S M, Jeon C H. Low-Temperature Oxidation Reactivity of Low-Rank Coals and Their Petrographic Properties. ACS Omega 2020; 5:18594-601. https://doi.org/10.1021/acsomega.0c00840.
[93] Yao Y. Enhancement of mass transfer by ultrasound: Application to adsorbent regeneration and food drying/dehydration. Ultrason Sonochem 2016; 31:512-31. https://doi.org/10.1016/j.ultsonch.2016.01.039.
[94] Asgharzadehahmadi S, Davoody M, Ghotli R A, Abdul Raman A A, Parthasarathy R. Effect of ultrasonic irradiations on gas-liquid mass transfer coefficient (kLa); Experiments and modelling. Meas J Int Meas Confed 2016; 79:119-29. https://doi.org/10.1016/j.-measurement.2015.10.034.
[95] Arefi-Oskoui S, Khataee A, Safarpour M, Orooji Y, Vatanpour V. A review on the applications of ultrasonic technology in membrane bioreactors. Ultrason Sonochem 2019; 58:104633. https://doi.org/10.1016/j.ultsonch.2019.104633.
[96] Saien J, Daneshamoz S. Experimental studies on the effect of ultrasonic waves on single drop liquid-liquid extraction. Ultrason Sonochem 2018; 40:11-6. https://doi.org/10.1016/-j.ultsonch.2017.06.020.

1. A process for producing humic acids from a solid carbonaceous feedstock comprising a humic substance content and a carbon content, the process comprising:
mixing a comminuted carbonaceous solids fraction derived from the solid carbonaceous feedstock with an alkaline solution to produce a pre-solubilized slurry, wherein the slurry is characterized by a weight ratio of comminuted carbonaceous solids to water of from 1:20 to 1:7;
treating the pre-solubilized slurry under extraction conditions in a basic aqueous extraction medium for an effective extraction residence time period of less than 1 hour to extract humic acids from the comminuted carbonaceous solids, wherein the extraction conditions comprise:
ultrasonic sonication at 10-30 kHz;
H₂O₂ at an H₂O₂ concentration of between 1% and 5%;
an extraction temperature of from 25° C. to 60° C.;
KOH and NH₄OH, wherein the NH₄OH is present at an N:K molar ratio to the KOH, and wherein the N:K molar ratio is from 0.5:1 to 1:0.5, and wherein the NH₄OH and KOH are present in a combined concentration that maintains alkaline conditions of pH 8 to 12 in the presence of the H₂O2;
wherein the extraction conditions are effective during the extraction residence time period:
to solubilize at least 90% of the carbon content of the carbonaceous feedstock, and
to covalently incorporate nitrogen and potassium into a humic acids product; and,
separating a humic acid solution product stream from residual solids and recovering the humic acid solution product stream, wherein the humic acid solution product stream comprises the humic acids product and a fulvic acids product, wherein the conversion of the humic substance content of the carbonaceous feedstock into the humic acids product of the humic acid solution product stream provides an ash-free humic acid yield of at least 70%; and wherein the proportion of the humic substance content of the carbonaceous feedstock converted to CO₂ under the extraction conditions during the extraction time period is less than 1%.

2. The process of claim 1, wherein the carbonaceous feedstock comprises a coal, a biochar, a petroleum coke or an asphaltene.

3. The process of claim 1, wherein the carbonaceous feedstock comprises a lignite coal, a sub-bituminous coal, a humalite, a leonardite or a peat.

4. The process of any one of claims 1-3, wherein the comminuted carbonaceous solids fraction is derived from the solid carbonaceous feedstock by being comminuted to a size of 50-950 μm, optionally 50-750 μm.

5. The process of any one of claims 1-4, wherein conversion of the humic substance content of the carbonaceous feedstock into the humic acids product of the humic acid solution product stream provides an ash-free humic acid yield of at least at least 70%.

6. The process of any one of claims 1-5, wherein the effective extraction residence time period is less than about 1 hour.

7. The process of any one of claims 1-6, wherein the process is a continuous process.

8. The process of any one of claims 1-6, wherein the process is a batch process.

9. The process of any one of claims 1-8, further comprising acidifying the humic acid solution product stream to precipitate the humic acids product.
